(19) United States
(12) Patent Application Publication
(10) Pub. No.: US 2024/0276479 A1
(43) Pub. Date: Aug. 15, 2024

(54) METHOD AND APPARATUS FOR DEVICE IDENTIFICATION IN A COMMUNICATION NETWORK

(71) Applicant: Marvell Asia Pte Ltd, Singapore (SG)

(72) Inventors: Eve Yuhua HUANG, San Jose, CA (US); Hon Wai FUNG, Newark, CA (US); Daryl HOOT, Saratoga, CA (US); Tsungtang WANG, San Jose, CA (US); Shruthi GADEY, San Jose, CA (US); Van LY, San Jose, CA (US); Dance WU, Palo Alto, CA (US)

(21) Appl. No.: 18/439,605

(22) Filed: Feb. 12, 2024

Related U.S. Application Data
(60) Provisional application No. 63/444,860, filed on Feb. 10, 2023.

(51) Int. Cl. H04W 72/12

(52) U.S. Cl. CPC H04W 72/12

(57) ABSTRACT

A coordinator communication device operates in a communication network according to a communication protocol that defines repeating time cycles and specifies that each of multiple communication devices is provided a respective transmit opportunity in each time cycle. The coordinator communication device determines a number of follower communication devices in a communication network while the follower communication devices are selecting transmit opportunities using respective initial device identifiers. The coordinator communication device determines a quantity of transmit opportunities to be provided in each of multiple time cycles during which the follower communication devices are selecting transmit opportunities using respective new device identifiers. The coordinator communication device determines the quantity of transmit opportunities at least by using the number of follower communication devices. While the follower communication devices are selecting transmit opportunities using the respective new device identifiers, the coordinator communication device provides the quantity of transmit opportunity periods in each time cycle.

### CROSS REFERENCES TO RELATED APPLICATIONS

This application claims the benefit of U.S. Provisional Patent App. No. 63/542,289, entitled “10Base-TIs Node ID Discovery,” filed on Feb. 10, 2023, the disclosure of which is expressly incorporated herein by reference in its entirety.

### FIELD OF TECHNOLOGY

The present disclosure relates generally to communication networks, and more particularly to determining identifiers of communication devices on a communication network.

### BACKGROUND

Some communication networks use a shared communication medium, and such communication networks often use collision avoidance techniques for avoiding situations in which multiple communication devices transmit at the same time (a “collision”), which typically prevents one or more of the transmissions from being correctly received. For example, some communication networks use a token ring method in which a communication device can only transmit on the communication medium when the communication device is in possession of a token (typically a set of bits), where the token is passed from communication device to communication device in the network so that only one communication device has the token at any given time. As another example, some communication networks use a time-division multiple access (TDMA) technique in which communication devices are assigned respective time slots in which the communication devices are permitted to transmit on the communication medium, where each time slot is typically only assigned a single communication device.

The Institute for Electrical and Electronics Engineers (IEEE) Standard 802.3cg defines a physical layer (PHY)-level collision avoidance (PLCA) technique in which transmit opportunities for devices in a network are scheduled in repeating time cycles. Each time cycle begins with a coordinator transmitting a beacon transmission, which signals to follower devices that a new time cycle has begun. Each device in the network has a respective node identifier (ID) from a set of values 0, 1, 2, . . . , N−1, where N is a maximum number of devices permitted by the communication protocol in a network. The node ID defines an ordering of transmit opportunities during the time cycle. For example, a first-occurring transmit opportunity corresponding to node ID 0 (the coordinator) begins after the beacon transmission; a next-occurring transmit opportunity corresponding to node ID 1 begins after the transmit opportunity corresponding to node ID 0 ends; a next-occurring transmit opportunity corresponding to node ID 2 begins after the transmit opportunity corresponding to node ID 1 ends; etc. When the transmit opportunity corresponding to node ID M ends, where M is a highest node ID in the network, the time cycle ends, and the coordinator transmits a next beacon transmission to signal that a new time cycle has begun.

### SUMMARY

In an embodiment, a method is for providing transmission opportunities in a communication network that operates according to a communication protocol, the communication protocol defining repeating time cycles, wherein the communication protocol specifies that each of multiple communication devices is provided a respective transmit opportunity in each time cycle. The method includes: determining, at a coordinator communication device, a number of follower communication devices in the communication network while the follower communication devices are selecting transmit opportunities using respective initial device identifiers; determining, at the coordinator communication device, a quantity of transmit opportunities to be provided in each time cycle during which the follower communication devices are selecting transmit opportunities using respective new device identifiers, including determining the quantity of transmit opportunities using the number of follower communication devices; and while the follower communication devices are selecting transmit opportunities using the respective new device identifiers, providing, by the coordinator communication device, the quantity of transmit opportunity periods in each time cycle.

In another embodiment, a network interface device is for communicating in a communication network that operates according to a communication protocol, the communication protocol defining repeating time cycles, wherein the communication protocol specifies that each of multiple communication devices is provided a respective transmit opportunity in each time cycle. The network interface device is configured to operate as a coordinator communication device and comprises: receiver circuitry; transmit circuitry; and controller circuitry. The controller circuitry is configured to: determine a number of follower communication devices in the communication network while the follower communication devices are selecting transmit opportunities using respective initial device identifiers; determine a quantity of transmit opportunities to be provided in each time cycle during which the follower communication devices are selecting transmit opportunities using respective new device identifiers, including determining the quantity of transmit opportunities using the number of follower communication devices; and while the follower communication devices are selecting transmit opportunities using the respective new device identifiers, provide the quantity of transmit opportunity periods in each time cycle.

In yet another embodiment, a method is for determining an identifier for a communication device in a communication network that operates according to a communication protocol, the communication protocol defining repeating time cycles, wherein the communication protocol specifies that each of multiple communication devices is provided a respective transmit opportunity in each time cycle. The method includes: determining, at a follower communication device, a quantity of transmit opportunities in which one or more other follower communication devices in the communication network transmitted while the one or more other follower communication devices are selecting transmit opportunities using one or more respective initial device identifiers; determining, at the follower communication device, a new identifier of the follower communication device using the quantity of transmit opportunities in which the one or more other follower communication devices in the communication network transmitted; and after determining the new identifier of the follower communication device, selecting, by the follower communication device, transmit opportunities for the follower communication device that correspond to the new device identifier.

In another embodiment, a network interface device is for communicating in a communication network that operates according to a communication protocol, the communication protocol defining repeating time cycles, wherein the communication protocol specifies that each of multiple communication devices is provided a respective transmit opportunity in each time cycle. The network interface device is configured to operate as a follower communication device and comprises: receiver circuitry; transmit circuitry; and controller circuitry. The controller circuitry is configured to: determine a quantity of transmit opportunities in which one or more other follower communication devices in the communication network transmitted while the one or more other follower communication devices are selecting transmit opportunities using one or more respective initial device identifiers; determine a new identifier of the follower communication device using the quantity of transmit opportunities in which the one or more other follower communication devices in the communication network transmitted; and after determining the new identifier of the follower communication device, select transmit opportunities for the follower communication device that correspond to the new device identifier.

### BRIEF DESCRIPTION OF THE DRAWINGS

FIG. 1 is a timing diagram illustrating a time schedule corresponding to a physical layer (PHY)-level collision avoidance (PLCA) technique of the Institute for Electrical and Electronics Engineers (IEEE) Standard 802.3cg.

FIG. 2 is a timing diagram of a time cycle for a communication network in which devices in the communication network have non-consecutive node identifiers (IDs).

FIG. 3A is simplified diagram of an example in-vehicle communication network in which various aspects, features, and elements described herein are implemented in accordance with various embodiments of this disclosure.

FIG. 3B is a simplified diagram of a vehicle that includes the in-vehicle communication network of FIG. 3A, according to an illustrative embodiment.

FIG. 4A is a timing diagram illustrating example phases of operation in connection with a node ID discovery procedure in a communication network such as the example communication network of FIG. 3A, according to an embodiment.

FIG. 4B is a timing diagram illustrating an example of a node ID discovery procedure announcement phase of the timing diagram of FIG. 4A, according to an embodiment.

FIG. 4C is a timing diagram illustrating an example of a node ID discovery phase of the timing diagram of FIG. 4A, according to an embodiment.

FIG. 4D is a timing diagram illustrating an example time cycle during a regular operation phase after the node ID discovery phase of FIGS. 4A and 4C, according to an embodiment.

FIG. 5 is a diagram illustrating an example data unit that a controller of the coordinator device of FIG. 3A uses to record information that indicates in which transmit opportunities transmissions occurred during a node ID discovery procedure, according to an embodiment.

FIG. 6 is a simplified example state transition diagram that a controller of the coordinator device of FIG. 3A is configured to implement, according to an embodiment.

FIG. 7 is a simplified example state transition diagram that a controller of the follower device of FIG. 3A is configured to implement, according to an embodiment.

FIG. 8 is a flow diagram of an example method for providing transmission opportunities in a communication network, according to an embodiment.

FIG. 9 is a flow diagram of another example method for providing transmission opportunities in a communication network, according to another embodiment.

FIG. 10 is a flow diagram of an example method for determining an identifier of a communication device in a communication network, according to an embodiment.

FIG. 11 is a flow diagram of another example method for determining an identifier of a communication device in a communication network, according to another embodiment.

FIG. 12 is a timing diagram illustrating an example time cycle during a regular operation phase after a node ID discovery operation, according to an embodiment.

FIG. 13 is a flow diagram of an example method for error handling in a communication network, according to an embodiment.

FIG. 14 is a flow diagram of another example method for error handling in a communication network, according to another embodiment.

### DETAILED DESCRIPTION

As discussed above, the Institute for Electrical and Electronics Engineers (IEEE) Standard 802.3cg defines a physical layer (PHY)-level collision avoidance (PLCA) technique in which transmit opportunities for devices in a network are scheduled in repeating time cycles. During each time cycle, a transmit opportunity is provided for each of multiple consecutive node identifiers (IDs) from a set of values 0, 1, 2, . . . , M, where M is a highest node ID from among devices in the communication network. During each transmit opportunity, if there is a device whose node ID corresponds to the transmit opportunity, the device is permitted to begin transmitting. Each transmit opportunity has a minimum duration Tmin. Thus, if there is no transmission during a transmit opportunity, the transmit opportunity has a duration of Tmin. Otherwise, if a device with the node ID that corresponds to the transmit opportunity begins transmitting during the transmit opportunity, the transmit opportunity ends when the device ends the transmission, assuming a duration of the transmission is greater than Tmin. Each device determines when a transmit opportunity ends based on either: i) if there is not transmission during the transmit opportunity, measuring a time duration from when the transmit opportunity began and determining when the time duration equals Tmin; or ii) if there is a transmission, determining when the transmission has ended.

Node IDs are sometimes referred to herein as “device identifiers” or “device IDs.”

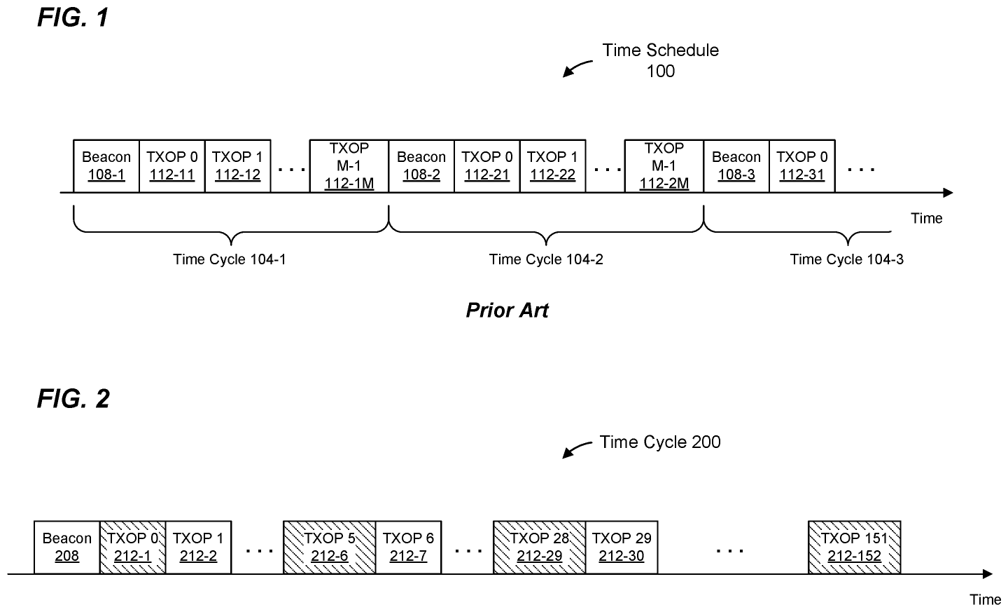

FIG. 1 is a timing diagram illustrating a time schedule 100 corresponding to the PLCA technique of the IEEE Standard 802.3cg. The time schedule 100 includes a plurality of repeating time cycles 104. Each time cycle 104 begins with a coordinator device transmitting a beacon signal 108 that signals to the follower devices that a new time cycle 104 has begun. During each time cycle 104, a transmit opportunity 112 is provided for each of multiple consecutive node IDs. For example, the transmit opportunity 112-1 (corresponding to node ID 0 (the coordinator device)) is provided after the beacon signal 108 ends; the transmit opportunity 112-2 for node ID 1 is provided after the transmit opportunity 112-1; the transmit opportunity 112-3 for node ID 2 is provided after the transmit opportunity 112-1; etc. When the transmit opportunity 112-M ends, the time cycle 104 ends, and the coordinator device transmits a next beacon signal 108 to signal to the follower devices that a new time cycle 104 has begun.

During a transmit opportunity 112, a communication device with a node ID that corresponds to the transmit opportunity 112 is permitted to begin transmitting. Each transmit opportunity 112 has a minimum duration Tmin. Thus, if no transmissions occur during the transmit opportunity 112 (e.g., because there is no communication device in the network with the corresponding node ID, or because a communication device with the corresponding node ID has nothing to transmit), the transmit opportunity 112 has a duration of Tmin. Otherwise, if a communication device with a node ID that corresponds to the transmit opportunity 112 begins transmitting during the transmit opportunity 112, the transmit opportunity 112 ends when the transmission ends, assuming a duration of the transmission is greater than Tmin. Thus, communication devices in the communication network determine when a transmit opportunity 112 ends based on measuring a time duration from when the transmit opportunity 112 began, and determining when the time duration equals Tmin, according to an embodiment. Additionally, in a scenario in which a transmission begins during a transmit opportunity 112, communication devices in the communication network determine when the transmit opportunity 112 ends based on determining when the transmission has ended, according to an embodiment.

Each of at least some communication devices in the communication network includes a counter that maintains a count that indicates a current transmit opportunity 112 during the time cycle 104, in an embodiment. For example, the communication device increments the counter in response to determining that a transmit opportunity 112 has ended. When the counter of the coordinator device indicates that the current transmit opportunity 112 is a last transmit opportunity in the time cycle 104 (i.e., the transmit opportunity 112-M), and in connection with (e.g., in response to) the transmit opportunity 112-M ending, the coordinator device transmits the beacon 108 to signal to the follower devices that a new time cycle 104 is beginning. When a follower device receives the beacon 108, the follower device resets the counter to zero.

In some communication networks that use the PLCA technique described above, devices in the communication network are assigned node IDs that are unique within the communication network but that are not consecutive within the communication network. For example, a node ID for a device is determined based on a globally unique identifier (GUID) assigned to the device at manufacture, such as a globally unique media access control (MAC) address. Because the node IDs of devices in the communication network (referred herein as “used node IDs”) are not consecutive, devices in the communication network will provide transmit opportunities that correspond to node IDs that are not used by any communication devices in the communication network (referred to herein as “unused node IDs”). As a result, throughput and/or latency in the communication network is adversely affected.

FIG. 2 is a timing diagram of a time cycle 200 for a communication network in which devices in the communication network have non-consecutive node IDs. The time cycle 200 is similar to the time cycles 104 of FIG. 1. For instance, the time cycle 200 begins with a coordinator device transmitting a beacon signal 208 that signals to the follower devices that the time cycle 200 has begun. Additionally, a transmit opportunity 212 is provided for each of multiple consecutive node IDs.

In the example of FIG. 2, the communication network includes a coordinator device that is assigned the node ID 0, and three follower devices that are assigned respective node IDs of 5, 28, and 151. Thus, the transmit opportunity 212-1 corresponds to the coordinator device, and the transmit opportunities 212-6, 212-29, and 212-152 corresponds to the follower devices with node IDs 5, 28, and 151, respectively.

The transmit opportunities 212-2 through 212-5, 212-7 through 212-28, and 212-30 through 212-151 correspond to unused node IDs, i.e., there are no communication devices with node IDs that correspond to these transmit opportunities. Thus, no transmissions should occur during the transmit opportunities 212-2 through 212-5, 212-7 through 212-28, and 212-30 through 212-151. However, the PLCA technique of the IEEE Standard 802.3cg requires that communications devices in the communication network must wait the minimum time duration, Tmin, during each of the transmit opportunities 212-2 through 212-5, 212-7 through 212-28, and 212-30 through 212-151. Thus, a significant amount of medium time is essentially wasted on transmit opportunities 212 that no communication device in the communication network will use. For instance, in the example of FIG. 2, the network cycles through 151 transmit opportunities 212 even though there are only four communication devices (i.e., one coordinator and three followers) on the network. In the example of FIG. 2, the network spends an amount of medium time equal to 147*Tmin on transmit opportunities that no communication device in the communication network will use.

In embodiments described below, a coordinator device in a shared communication medium network prompts follower communication devices to perform a procedure that causes one or more follower devices to select new node IDs so that a quantity of unused node IDs in the communication network below a highest used node ID are significantly reduced as compared to a scenario such as the scenario illustrated in FIG. 2. For example, the new node IDs are selected so that node IDs in the communication network are consecutively numbered so that there are no unused node IDs below the highest used node ID. Because the number of unused node IDs below the highest used node ID is significantly reduced, the number of transmit opportunities 212 corresponding to unused node IDs is significantly reduced as compared to a scenario such as the scenario illustrated in FIG. 2. Because the number of transmit opportunities 212 corresponding to unused node IDs is significantly reduced, the throughput and/or latency of the communication network is significantly improved as compared to a scenario such as the scenario illustrated in FIG. 2.

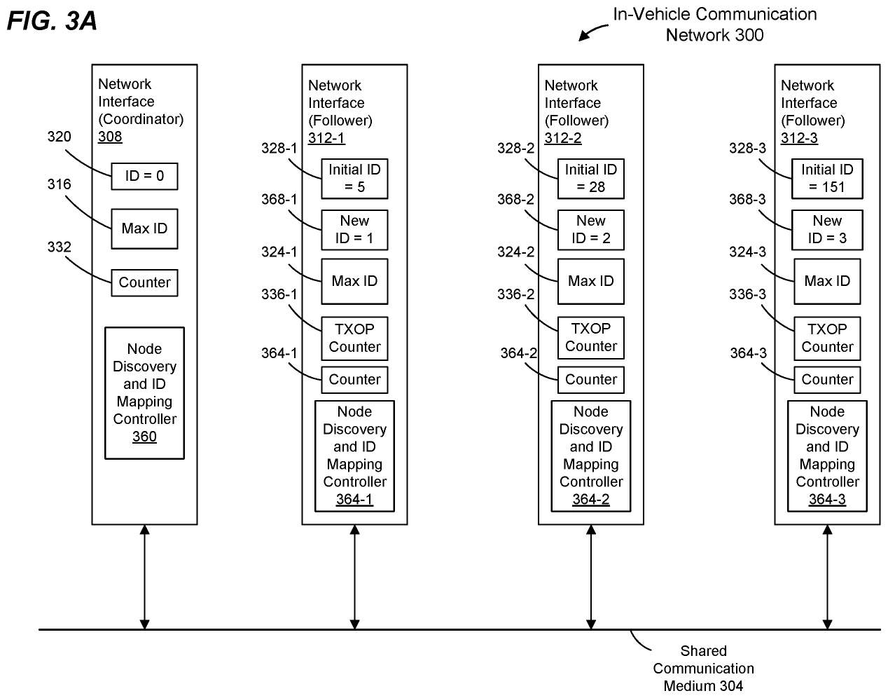

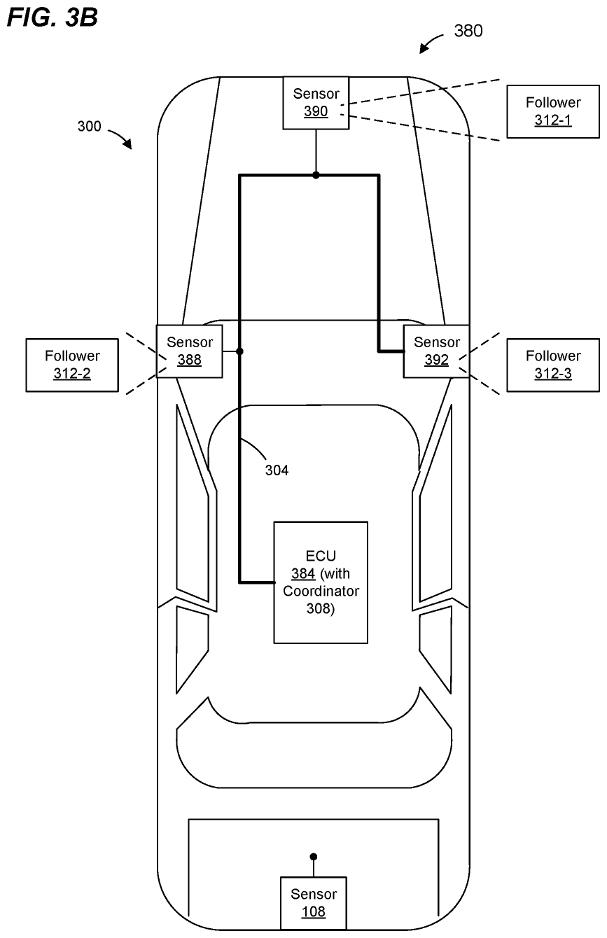

FIG. 3A is simplified diagram of an example in-vehicle communication network 300 in which various aspects, features, and elements described herein are implemented in accordance with various embodiments of this disclosure. The communication network 300 includes a shared communication medium 304, which comprises a twisted-pair cable, i.e., a pair of twisted metallic wires, in an embodiment. In other embodiments, the shared communication medium 304 comprises another suitable communication medium, such as a cable with multiple twisted pairs of metallic wires, a coaxial cable, over-the-air, etc.

Multiple network interfaces 308, 312 are communicatively coupled to the shared communication medium 304 and are configured to communicate via the shared communication medium 304. In an embodiment, the multiple network interfaces 308, 312 are configured to operate according to a communication protocol defined by the IEEE Standard 802.3cg, and FIG. 3A is described with reference to the IEEE Standard 802.3cg merely for explanatory purposes. In other embodiments, the multiple network interfaces 308, 312 are configured to operate according to other suitable communication protocols.

The network interface 308 is included in an electronic control unit (ECU) of a vehicle, in an embodiment. The ECU also includes a processor and a memory coupled to the processor (not shown), in an embodiment. The memory stores machine readable instructions that, when executed by the processor, cause the processor to perform various acts such as described herein.

Each of at least some of the network interfaces 312 corresponds to a vehicle component that includes one or more of: i) a sensor (e.g., a touchscreen, a pressure sensor, a camera, a RADAR sensor, a LIDAR sensor, a temperature sensor, etc.), ii) an actuator (e.g., an actuator to operate a door lock, a switch, a brake, etc.), iii) a controller, etc. In some embodiments, each of at least some of the network interfaces 312 is coupled to a processor and/or a memory coupled to the processor (not shown), in an embodiment. The memory stores machine readable instructions that, when executed by the processor, cause the processor to perform various acts such as described herein.

The network interface 308 corresponds to a coordinator communication device (sometimes referred to herein as “the coordinator 308” for brevity), and the network interfaces 312 correspond to respective follower communication devices (sometimes referred to herein as “the followers 312” for brevity). The coordinator 308 includes a memory 316 (e.g., a register, one or more locations in a memory device such as a random access memory (RAM), a solid state memory, etc.) that stores a value of a parameter that indicates a highest node ID, M, of network interfaces 312 in the communication network 300. The parameter that indicates the highest node ID in the communication network 100 is sometimes referred to herein as “M” for brevity. In another embodiment, the memory 316 stores P, which is a number of transmit opportunities to be provided by the coordinator 308 in each time cycle; or the coordinator 308 includes another memory (not shown) similar to the memory 316 that stores P. The coordinator 308 is configured to maintain M (and/or P), in some embodiments. . For example, the coordinator 308 determines M (and/or P) and stores M (and/or P) in the memory 316 and/or in the other memory (not shown).

According to the IEEE Standard 802.3cg, each of the network interfaces 108, 112 has a respective node identifier (ID) selected from a set of values {0, 1, 2, . . . , N−1}, where N is a maximum number of communication devices permitted in a communication network by the IEEE Standard 802.3cg. More specifically, the network interface 308 (coordinator) has the node ID 0, and the network interfaces 312 (followers) have respective node IDs selected from a set of values {1, 2, . . . , N−1}, where N is a maximum number of devices permitted by the communication protocol according to which the communication network 300 operates, e.g., the protocol defined by the IEEE Standard 802.3cg.

Although three followers 312 are illustrated in FIG. 3A as an illustrative example, the communication network 300 includes another suitable number of followers 312 less than N, in other embodiments.

The coordinator 308 includes a memory 320 (e.g., a register, one or more locations in a memory device such as a RAM, a solid state memory, etc.) that stores the node ID of the coordinator 308. In an embodiment, the memory 316 and the memory 320 correspond to different memory devices (e.g., different registers, different RAMs, different solid state memories, etc.). In another embodiment, the memory 316 and the memory 320 correspond to different sets of one or more memory locations in a single memory device.

Each follower 312 includes a memory 324 (e.g., a register, one or more locations in a memory device such as a RAM, a solid state memory, etc.) that stores M, i.e., the highest (or maximum) node ID of network interfaces 312 in the communication network 300. In another embodiment, the memory 324 stores P, which is a number of transmit opportunities to be provided by the coordinator 308 in each time cycle; or the follower 312 includes another memory (not shown) similar to the memory 324 that stores P. Each follower 312 is configured to maintain M (and/or P). For example, each follower 312 determines M (and/or P) and stores the value that indicates M (and/or P) in the memory 324 and/or the other memory (not shown). In other embodiments, the memory 324 is omitted and the followers 312 do not maintain M (nor P).

Each follower 312 also includes a memory 328 (e.g., a register, one or more locations in a memory device such as a RAM, a solid state memory, electronic fuses (e-Fuses), etc.) that stores an initial node ID of the follower 312. The initial node ID is a device identifier that is unique within the communication network 300. In some embodiments, the initial node ID is assigned to the follower 312 by a manufacturer of the follower 312, a manufacturer of a vehicle component that includes the follower 312, a manufacturer of a vehicle that includes the follower 312, etc. In some embodiments, the initial node ID is determined using a GUID assigned to the follower 312, such as a MAC address. In some embodiments, the GUID is assigned to the follower 312 by a manufacturer of the follower 312, a manufacturer of a vehicle component that includes the follower 312, a manufacturer of a vehicle that includes the follower 312, etc., and the follower 312 is configured to generate the initial ID using the GUID. In other embodiments, the initial ID is determined in another suitable manner that does not rely on a GUID assigned to the follower 312.

In an embodiment, the initial IDs of the followers 312 belong to a set of values 0, 1, 2, . . . , N−1. However, as discussed above, the initial IDs of the followers 312 typically are not consecutively numbered. For example, in the illustrative example of FIG. 3A, the followers 312-1, 312-2, and 312-3 have initial ID values of 5, 28, and 151, respectively, and no communication devices in the communication network 300 have initial ID values 1-4 and 29-150. As discussed above, when node IDs are not consecutively numbered such as with the initial node IDs of the followers 312, transmit opportunities will be provided for node IDs that are not assigned to any followers 312, and therefore medium time is essentially wasted on such transmit opportunities.

In some embodiments, the memory 324 and the memory 328 correspond to different memory devices. In other embodiments, the memory 324 and the memory 328 correspond to different sets of one or more memory locations in a single memory device.

As discussed above, the PLCA technique of the IEEE Standard 802.3cg defines repeating time cycles in which transmit opportunities for the network interfaces 308, 312 in the communication network 300 are scheduled. Each time cycle begins with the coordinator 308 transmitting a beacon transmission, which signals to the followers 312 that a new time cycle has begun. The node IDs of the network interfaces 308, 312 define an ordering of transmit opportunities during the time cycle. As discussed above, when the node IDs of the followers 312 are not consecutively numbered, transmit opportunities will be allotted to unused node IDs, thus adversely affecting throughput and/or latency of the communication network 300.

Referring now to FIGS. 1 and 3, each network interface 308, 312 includes a counter that maintains a count that indicates a current transmit opportunity 112 during the time cycle 104, in an embodiment. For instance, the coordinator 308 includes a counter 332, and the followers 112 include respective counters 336, in an embodiment. The counters 332, 336 are used by the network interfaces 308, 312 to keep track of a current transmit opportunity 112, in an embodiment. For example, each network interface 308, 312 increments the counter 332, 336 in response to determining that a transmit opportunity 112 has ended, in an embodiment. In another embodiment, each network interface 308, 312 increments the counter 332, 336 in response to determining that a transmit opportunity 112 has begun.

In an embodiment, when the counter 332 indicates that the current transmit opportunity is the transmit opportunity 112-M, and in connection with (e.g., in response to) the transmit opportunity 112-M ending, the coordinator 308 resets the counter 332 to zero. Additionally, when the counter 332 indicates that the current transmit opportunity is the transmit opportunity 112-M, and in connection with (e.g., in response to) the transmit opportunity 112-M ending, the coordinator 308 transmits the beacon 108 to signal to the followers 312 that a new time cycle 104 is beginning.

Additionally, the follower 312 is configured to reset the counter 336 to zero in response to receiving a beacon 108 from the coordinator 308, in some embodiments. If a counter 336 of a follower 312 becomes offset from the time schedule 100 for some reason (e.g., the counter 336 indicates a count of 5 when the actual transmit opportunity 112 corresponds to a counter value of 6), resetting the counter 336 to zero in response to receiving a beacon 108 is useful for facilitating the follower 312 to resynchronize the counter 336 for a next time cycle 104.

The coordinator 308 includes a controller 360 that is configured to cause the coordinator 308 to participate in, and prompt the followers 312 to participate in, a procedure (sometimes referred to herein as the “node ID discovery procedure”) for i) identifying (at least by the coordinator 308) followers 312 on the communication network 300 and ii) determining new node IDs for followers 312 so that the amount of transmit opportunities that correspond unused node IDs is significantly reduced. For example, the new node IDs are determined so that at least some of the new node IDs are consecutively numbered, in an embodiment. Similarly, each follower 312 includes a controller 364 that is configured to cause the follower 312 to participate in the node ID discovery procedure.

In the node ID discovery procedure, the coordinator 308 provides a predetermined number of transmit opportunities such as the maximum number of transmit opportunities permitted by the communication protocol (i.e., N transmit opportunities), or another suitable value. For example, a manufacturer (e.g., of components such as the coordinator 308 and the followers 312; of vehicles; etc.) may set a maximum number (Q) of devices permitted on a communication network such as the network 300 to a value less than N (i.e., Q<N), and the predetermined number of transmit opportunities provided by the coordinator 308 during the node ID discovery procedure is set based on Q (e.g., equal to Q, equal to Q+B, where B is a suitable positive integer, etc.).

Also, each follower 312 transmits during a transmit opportunity that corresponds to the initial ID of the follower 312 and remains silent during other transmit opportunities that do not correspond to the initial ID of the follower 312. The transmission by the follower 312 during the node ID discovery procedure is any suitable transmission for being detected by the coordinator 308 and other followers 312. For example, the IEEE Standard 802.3cg defines a COMMIT transmission pattern that followers can transmit during a transmit opportunity to hold the transmit opportunity until the follower is ready to transmit a packet, and the controller 364 is configured to cause the follower 312 to transmit the COMMIT pattern during the transmit opportunity that corresponds to the initial ID of the follower 312, in an embodiment. In another embodiment, the follower 312 transmits a packet during the transmit opportunity that corresponds to the initial ID of the follower 312, where the packet comprises any suitable information, including dummy information. In another embodiment, the follower 312 transmits a null data packet (NDP) during the transmit opportunity that corresponds to the initial ID of the follower 312, where the NDP packet includes a preamble and/or a header, but omits a payload.

The controller 364 of the follower 312 is configured to count a number of transmit opportunities, prior to the transmit opportunity corresponding to the initial ID of the follower 312, in which transmissions occurred, in an embodiment. For example, each follower 312 includes a counter that the follower 312 uses to count the number of transmit opportunities, prior to the transmit opportunity corresponding to the initial ID of the follower 312, in which transmissions occurred. The controller 364 uses the count of transmit opportunities, prior to the transmit opportunity corresponding to the initial ID of the follower 312, in which transmissions occurred to determine a new node ID for the follower 312, in an embodiment. For example, if the controller 364 counted X transmit opportunities, prior to the transmit opportunity corresponding to the initial ID of the follower 312, in which transmissions occurred, the controller 364 sets the new node ID of the follower 312 to X+1, in an embodiment. In this manner, the controllers 364 of the followers 312 will select new node IDs that are consecutively numbered, in an embodiment. In other embodiments, new node IDs are selected in another suitable manner in which at least some of the new node IDs are not consecutively numbered but yet an amount of transmit opportunities that correspond unused node IDs is significantly reduced as compared to when the initial IDs are used by the followers 312 to select transmit opportunities. For example, the controller 364 sets the new node ID of the follower 312 to A*(X+1), where A is a suitable positive integer, in another embodiment. For instance, when A is two, one unused node ID will be included between each pair of new node IDs. Similarly, when A is three, two unused node IDs will be included between each pair of new node IDs.

In other embodiments, certain predetermined node ID values are reserved, e.g., to reserve transmit opportunities for uses such as reporting errors, providing transmit opportunities to newly added follower devices, etc. In such embodiments, the new node IDs are selected in a suitable manner so that follower devices 312 do not set the new node IDs to any of the reserved node ID values. As an illustrative example, if the first B transmit opportunities (after the transmit opportunity corresponding to node ID 0) are to be reserved, where B is a suitable positive integer, then the controller 364 sets the new node ID of the follower 312 to X+B+1. As another illustrative example, if the first B transmit opportunities (after the transmit opportunity corresponding to node ID 0) are to be reserved and A-1 unused node IDs are to be included between each pair of new node IDs, then the controller 364 sets the new node ID of the follower 312 to A*X+B+1.

In the example of FIG. 3A, the controller 364-1 of the follower 312-1 counts zero transmit opportunities, prior to the transmit opportunity that corresponds to the initial node ID 5, in which transmissions occurred, and therefore the controller 364-1 sets the new node ID of the follower 312-1 to one. Additionally, the controller 364-2 of the follower 312-2 counts one transmit opportunity, prior to the transmit opportunity that corresponds to the initial node ID 28, in which a transmission occurred, and therefore the controller 364-2 sets the new node ID of the follower 312-2 to two. Similarly, the controller 364-3 of the follower 312-3 counts two transmit opportunities, prior to the transmit opportunity that corresponds to the initial node ID 151, in which transmissions occurred, and therefore the controller 364-3 sets the new node ID of the follower 312-3 to three.

In some instances, the new node ID of a follower 312 will be the same as the initial ID of the follower 312. For example, if a follower has an initial ID of 1, the new node ID will also be 1. As another example, if a first follower 312 has an initial ID of 1 and a second follower 312 has an initial ID of 2, the new node ID of the first follower 312 will be 1 and the new node ID of the second follower 312 will be 2.

Similarly, the controller 360 of the coordinator 308 is configured to count a number of transmit opportunities during the node ID discovery procedure in which transmissions occurred, in an embodiment. The controller 360 uses the count of transmit opportunities during the node ID discovery procedure in which transmissions occurred to determine a number of followers in the communication network 300, in an embodiment. In some embodiments, the controller 360 determines the new node IDs for the followers 312. In some embodiments, the controller 360 records information that indicates in which transmit opportunities transmissions occurred, and the controller 360 uses the information to determine the number of followers in the communication network 300 and/or determine the new node IDs for the followers 312.

In the example of FIG. 3A, the controller 360 of the coordinator 308 counts three transmit opportunities during the node ID discovery procedure in which transmissions occurred, and therefore the controller 368 determines that the communication network 300 includes three followers 312. In an embodiment, the controller 360 also determines that the new node IDs of the three followers 312 are one, two, and three.

Each follower 312 includes a memory 368 (e.g., a register, one or more locations in a memory device such as a RAM, a solid state memory, etc.) configured to store the new node ID. For example, when the controller 364 determines the new node ID, such as discussed above, the controller 364 stores the new node ID in the memory 368, in an embodiment.

In an embodiment, the controller 364 is configured to determine a new highest (maximum) node ID of network interfaces 312 in the communication network 300 in connection with an end of the node ID discovery procedure, according to an embodiment. For example, the controller 364 counts a number of transmit opportunities in which transmissions occurred during the node ID discovery procedure to determine the new highest (maximum) node ID of network interfaces 312 in the communication network 300, in an embodiment. The controller 364 then stores the new highest (maximum) node ID of network interfaces 312 in the communication network 300 in the memory 324.

In another embodiment, the controller 364 is configured to determine a new value of P (i.e., the number of transmit opportunities to be provided by the coordinator 308 in each time cycle after the node ID discovery procedure) in connection with an end of the node ID discovery procedure. For example, the controller 364 counts a number of transmit opportunities in which transmissions occurred during the node ID discovery procedure to determine the new number of transmit opportunities to be provided by the coordinator 308 in each time cycle after the node ID discovery procedure. The controller 364 then stores the new value of P in the memory 324 or another suitable memory.

The controller 360 comprises a hardware state machine configured to perform acts such as described herein, according to an embodiment. The controller 360 additionally or alternatively includes a processor coupled to a memory storing machine readable instructions that, when executed by the processor, cause the processor to perform acts such as described herein, according to another embodiment.

The controller 364 comprises a hardware state machine configured to perform acts such as described herein, according to an embodiment. The controller 364 additionally or alternatively includes a processor coupled to a memory storing machine readable instructions that, when executed by the processor, cause the processor to perform acts such as described herein, according to another embodiment.

FIG. 3B is a simplified diagram of a vehicle 380 that includes the in-vehicle communication network 300 of FIG. 3A, according to an illustrative embodiment. In the example of FIG. 3B, the vehicle 380 includes an electronic control unit (ECU) 384 and sensors 388, 390, and 392 (e.g., radar sensors, lidar sensors, etc.), electrically connected to the communication medium 304 (e.g., a cable). The ECU 384 and the sensors 388, 390, 392 are communicatively coupled via the communication medium 304.

The ECU 384 includes the coordinator 308. The sensor 390 includes the follower 312-1; the sensor 388 includes the follower 312-2; and the sensor 392 includes the follower 312-3. The coordinator 308 is configured to communicate with the follower 312 via the communication medium 304.

In various embodiments, the ECU 384 also includes one or more of a processor, a memory, etc., (not shown). In an embodiment, one or more circuit components (e.g., one or more of the coordinator 308, the processor, etc.) are implemented as a system on a chip (SOC). One or more components of the ECU 384 (e.g., the SOC, etc.) are mounted on one or more printed circuit boards (PCBs), according to various embodiments. The one or more PCBs are mounted in a housing, in some embodiments.

Each of the sensors 388, 390, 392 corresponds to a vehicle subsystem assembly having the respective follower 312 implemented on one or more integrated circuits (ICs) (not shown). In various embodiments, each of the vehicle subsystem assemblies 388, 390, 392 also includes one or more of a controller, a memory, etc. (not shown), implemented on the same IC as the follower 312 or one or more other ICs. The controller comprises a hardware state machine, according to an embodiment. The controller additionally or alternatively includes a processor coupled to a memory storing machine readable instructions that, when executed by the processor, cause the processor to perform various acts, according to another embodiment.

Each vehicle subsystem assembly 388, 390, 392 includes one or more sensors communicatively coupled to the follower 312, in an embodiment. The follower 312 receives sensor data from the sensor and sends the sensor data to the ECU 384 (e.g., to the coordinator 308) via the communication medium 304, in an embodiment.

In another embodiment, each vehicle subsystem assembly 388, 390, 392 includes one or more actuators (referred to as “the actuator” for ease of explanation) communicatively coupled to the follower 312. In an embodiment in which a vehicle subsystem assembly 388, 390, 392 includes an actuator, the follower 312 receives control data from the ECU 384 via the communication medium 304 for controlling the actuator.

Although the communication network 300 of FIGS. 3A-B was described as being within a vehicle, in other embodiments the communication network 300 is in another suitable environment such as an industrial plant (e.g., a manufacturing plant, a process plant, etc.). Although FIG. 3B illustrates the vehicle 300 as a passenger automobile, in other embodiments the vehicle 300 comprises a truck, a motorcycle, a boat, a ship, an airplane, a human-powered vehicle, etc.

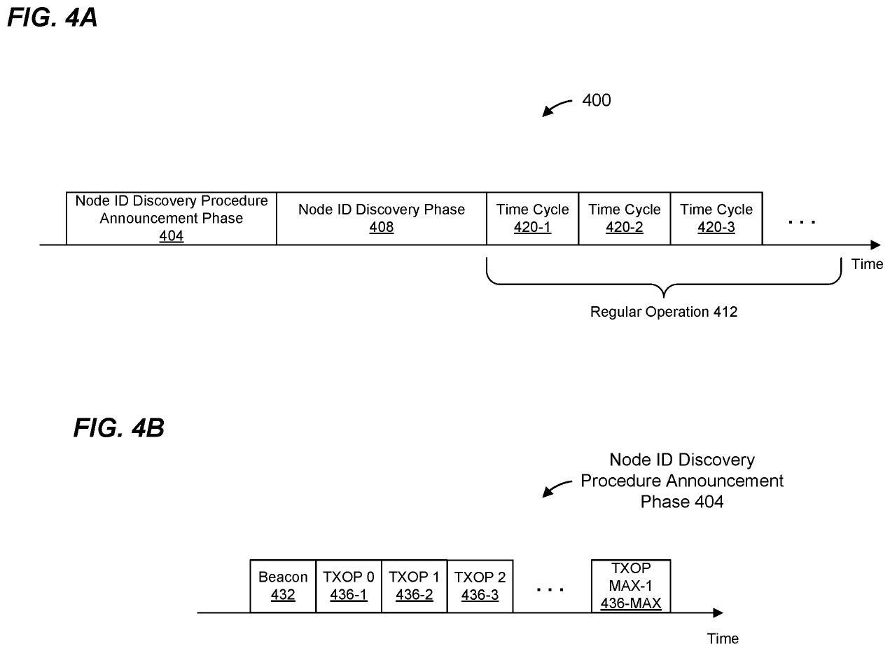

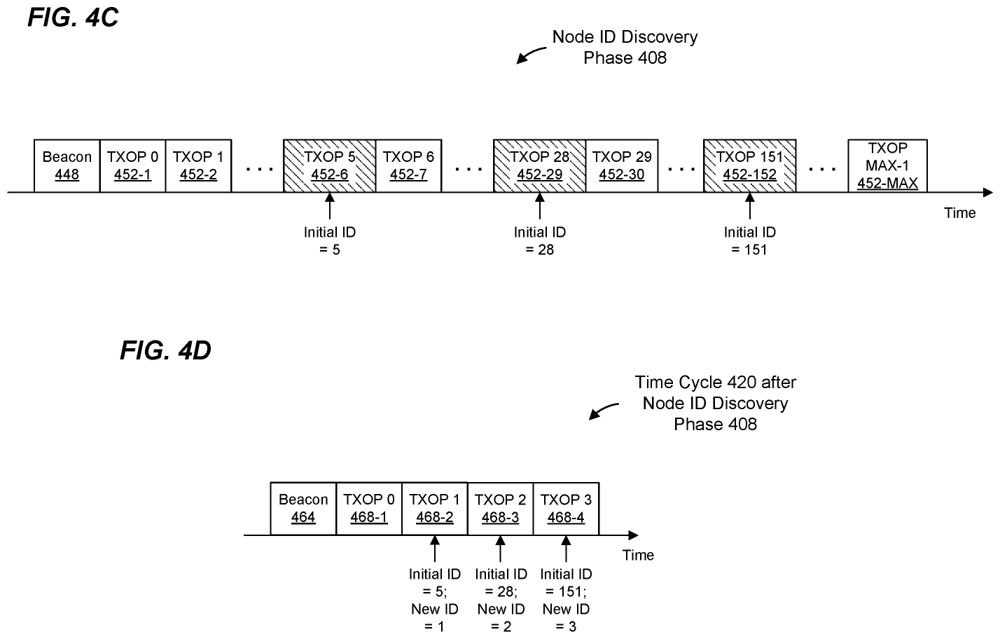

FIG. 4A is a timing diagram illustrating phases of operation in connection with a node ID discovery procedure in a communication network such as the example communication network 300 of FIG. 3A, according to an embodiment. In an embodiment, the phases of operation illustrated in FIG. 4A are performed in the communication network 300, and FIG. 4A is described with reference to FIG. 3A for case of explanation. In other embodiments, the phases of operation illustrated in FIG. 4A are performed by another suitable communication network different than the communication network 300.

In a node ID discovery procedure announcement phase (sometimes referred to herein as the “announcement phase”) 404, the coordinator 308 signals to followers 312 in the communication network 300 that a node ID discovery phase 408 will begin after the announcement phase 404. In an embodiment, the announcement phase 404 has a structure like the structure of the time cycles 104 of FIG. 1. For example, the coordinator 308 transmits a beacon at a beginning of the announcement phase 404 and provides one or more transmit opportunities after the beacon during the announcement phase 404.

In an embodiment, the coordinator 308 signals followers 312 that the node ID discovery phase 408 will begin by providing a number of transmit opportunities during the announcement phase 404 that corresponds to N, i.e., the maximum number of transmit opportunities permitted by the communication protocol. In an embodiment, providing N transmit opportunities during the announcement phase 404 comprises the coordinator 308 transmitting a first beacon at a beginning of the announcement phase 404; and the coordinator 308 transmitting a second beacon after an end of the announcement phase 404 so that a time duration from an end of the first beacon and a beginning of the second beacon corresponds to the N transmit opportunities.

an embodiment, the coordinator 308 signals followers 312 that the node ID discovery phase 408 will begin by providing a number of transmit opportunities during the announcement phase 404 that corresponds to Q, i.e., the maximum number of transmit opportunities permitted by the communication protocol that is less than N. In an embodiment, providing the number of transmit opportunities corresponding to Q during the announcement phase 404 comprises the coordinator 308 transmitting a first beacon at a beginning of the announcement phase 404; and the coordinator 308 transmitting a second beacon after an end of the announcement phase 404 so that a time duration from an end of the first beacon and a beginning of the second beacon corresponds to the number of transmit opportunities corresponding to Q.

In other embodiments, the coordinator 308 signals followers 312 that the node ID discovery phase 408 will begin in other suitable ways. For example, the coordinator 308 transmits a packet (e.g., a multicast packet, a broadcast packet, etc.) during a transmit opportunity of the coordinator 308 that signals followers 312 that the node ID discovery phase 408 will begin, in an embodiment.

During the node ID discovery phase 408, the coordinator 308 provides the maximum number of transmit opportunities (e.g., N transmit opportunities, Q transmit opportunities, etc.). Also, each follower 312 transmits during a transmit opportunity that corresponds to the initial ID of the follower 312 and remains silent during other transmit opportunities that do not correspond to the initial ID of the follower 312. In connection with an end of the node ID discovery phase 408, the followers 312 determine new node IDs in a manner such as described above with reference to FIG. 3A.

After the node ID discovery phase 408, the follower devices use the new node IDs in a regular operation phase 412, which includes time cycles 420 that each have a structure like the time cycles 104 of FIG. 1.

FIG. 4B is a timing diagram illustrating an example of the node ID discovery procedure announcement phase (the “announcement phase”) 404, according to an embodiment. The coordinator 308 transmits a beacon 432 in connection with a beginning of the announcement phase 404. Additionally, the coordinator 308 provides a number of transmit opportunities 436 during the announcement phase 404 that corresponds to N, i.e., the maximum number of transmit opportunities permitted by the communication protocol. In an embodiment, providing N transmit opportunities 436 during the announcement phase 404 comprises the coordinator 308 transmitting another beacon (not shown) after an end of the announcement phase 404 so that a time duration from an end of the beacon 432 and a beginning of the other beacon corresponds to the N transmit opportunities. In another embodiment, the coordinator 308 provides a number of transmit opportunities 436 during the announcement phase 404 that corresponds to Q, i.e., the maximum number of transmit opportunities that is less than N.

In response to a follower device 312 determining that the predetermined number of transmit opportunities (e.g., N, Q, etc.) occurred after the beacon 432, the follower device 312 then determines that the node ID discovery phase 408 is beginning.

In an embodiment corresponding to FIG. 4B and in which a follower device includes a counter (e.g., the counter 336) for counting transmit opportunities between beacons, the counter 336 will indicate the predetermined number of transmit opportunities (e.g., N, Q, etc.) in connection with an end of the announcement phase 404, which signals to the follower device 312 that the node ID discovery phase 408 is beginning.

FIG. 4C is a timing diagram illustrating an example of the node ID discovery phase 408, according to an embodiment. The coordinator 308 transmits a beacon 448 in connection with a beginning of the node ID discovery phase 408. Transmission of the beacon 448 begins in connection with an end of the last transmit opportunity 436 (i.e., transmit opportunity 436-MAX) of the announcement phase 404, in an embodiment.

Additionally, the coordinator 308 provides a number of transmit opportunities 452 during the node ID discovery phase 408 that corresponds to the maximum number of transmit opportunities permitted (e.g., N, Q, etc.). In an embodiment, providing the maximum number of transmit opportunities 452 during the node ID discovery phase 408 comprises the coordinator 308 transmitting another beacon (not shown) after an end of the node ID discovery phase 408 so that a time duration from an end of the beacon 448 and a beginning of the other beacon corresponds to the maximum number of transmit opportunities.

Each follower 312 transmits during a transmit opportunity 452 that corresponds to the initial ID of the follower 312 and remains silent during other transmit opportunities 452 that do not correspond to the initial ID of the follower 312. For example, the follower 312-1 with the initial node ID 5 transmits during the transmit opportunity 452-6; the follower 312-2 with the initial node ID 28 transmits during the transmit opportunity 452-29; and the follower 312-3 with the initial node ID 151 transmits during the transmit opportunity 452-152.

The transmission by the follower 312 during the node ID discovery phase 408 is any suitable transmission (such as the COMMIT transmission pattern, a packet, etc.) for being detected by the coordinator 308 and other followers 312.

Each follower 312 counts a number of transmit opportunities 452, prior to the transmit opportunity 452 corresponding to the initial ID of the follower 312, in which transmissions occurred, in an embodiment. In the example of FIG. 4C, the follower 312-1 counts zero transmit opportunities 452, prior to the transmit opportunity 452-6 that corresponds to the initial node ID 5, in which transmissions occurred, and therefore the controller 364-1 determines that the new node ID of the follower 312-1 is one. Additionally, the follower 312-2 counts one transmit opportunity 452, prior to the transmit opportunity 452-29 that corresponds to the initial node ID 28, in which a transmission occurred, and therefore the controller 364-2 determines that the new node ID of the follower 312-2 is two. Similarly, the follower 312-3 counts two transmit opportunities 452, prior to the transmit opportunity 452-152 that corresponds to the initial node ID 151, in which transmissions occurred, and therefore the controller 364-3 determines that the new node ID of the follower 312-3 is three.

In the example of FIG. 4C, the controller 360 of the coordinator 308 counts three transmit opportunities (i.e., transmit opportunities 452-6, 452-29, and 452-152) during the node ID discovery phase 408 in which transmissions occurred, and therefore the controller 368 determines that the communication network 300 includes three followers 312.

FIG. 4D is a timing diagram illustrating an example time cycle 420 during the regular operation phase 412 after the node ID discovery phase 408, according to an embodiment. The coordinator 308 transmits a beacon 464 in connection with a beginning of the time cycle 420. Transmission of the beacon 420 begins i) in connection with an end of the last transmit opportunity 452 (i.e., transmit opportunity 452-MAX) of the node ID discovery phase 408, or ii) in connection with an end of a last transmit opportunity of a previous time cycle 420, in an embodiment.

Additionally, the coordinator 308 provides a quantity of transmit opportunities 468 that corresponds to the quantity of follower devices 312 determined during the node ID discovery phase 408. In the example of FIG. 4D, the coordinator 308 provides four transmit opportunities 468—one for the coordinator 308 and three for the three followers 312. The transmit opportunity 468-1 corresponds to the leader 308; the transmit opportunity 468-2 corresponds to the follower 312 with the new node ID one (initial node ID 5); the transmit opportunity 468-3 corresponds to the follower 312 with the new node ID two (initial node ID 28); and the transmit opportunity 468-4 corresponds to the follower 312 with the new node ID three (initial node ID 151).

The time cycle 420 has a significantly shorter time duration as compared to a time cycle in which the transmit opportunities of the followers 312 are determined using their initial node IDs, which are not consecutively numbered.

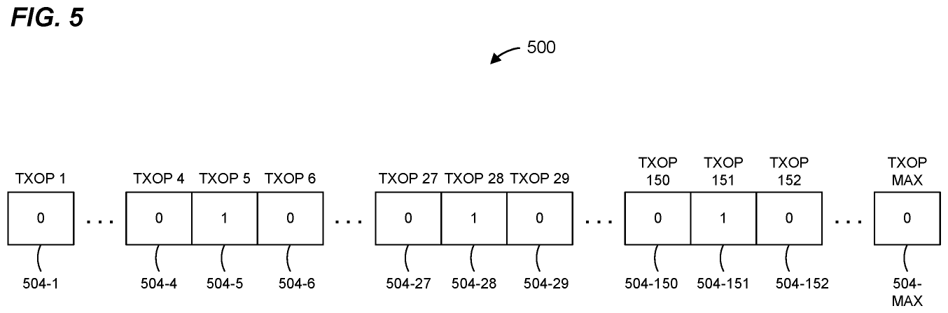

As discussed above with reference to FIG. 3A, the controller 360 records information that indicates in which transmit opportunities transmissions occurred during the node ID discovery procedure (e.g., during the node ID discovery phase 408 (FIGS. 4A, 4C), according to some embodiments. FIG. 5 is a diagram illustrating an example data unit 500 that the controller 360 uses to record information that indicates in which transmit opportunities transmissions occurred during the node ID discovery procedure, according to an embodiment.

The data unit 500 includes a plurality of subunits 504 that respectively correspond to the transmit opportunities 452 during the node ID discovery phase 408. In an embodiment, the data unit 500 comprises a bit map, and the subunits 504 are bits that respectively correspond to the transmit opportunities 452 during the node ID discovery phase 408. Prior to a first-occurring transmit opportunity (i.e., the transmit opportunity 452-2) that corresponds to a follower 312, the controller 360 initializes the data unit 500, in an embodiment. For example, the controller 360 sets all of the subunits 504 to a first value (e.g., logic zero or another suitable value) that corresponds to no transmission occurring during a transmit opportunity. Then, during the node ID discovery phase 408, when a transmission is detected in a transmit opportunity 452, the controller 360 sets the corresponding subunit 504 to a second value (e.g., logic one or another suitable value) that corresponds to a transmission detected during a transmit opportunity.

In connection with an end of the node ID discovery phase 408, the controller 360 uses the data unit 500 to determine a quantity of followers 312 on the communication network 300. For example, the controller 360 counts a number of subunits 504 having the second value. In some embodiments, the controller 360 additionally or alternatively uses the data unit 500 to determine new node IDs of the followers 312 in the communication network 300. In some embodiments, the controller 360 additionally or alternatively uses the data unit 500 to determine the initial node IDs of the followers 312 in the communication network 300.

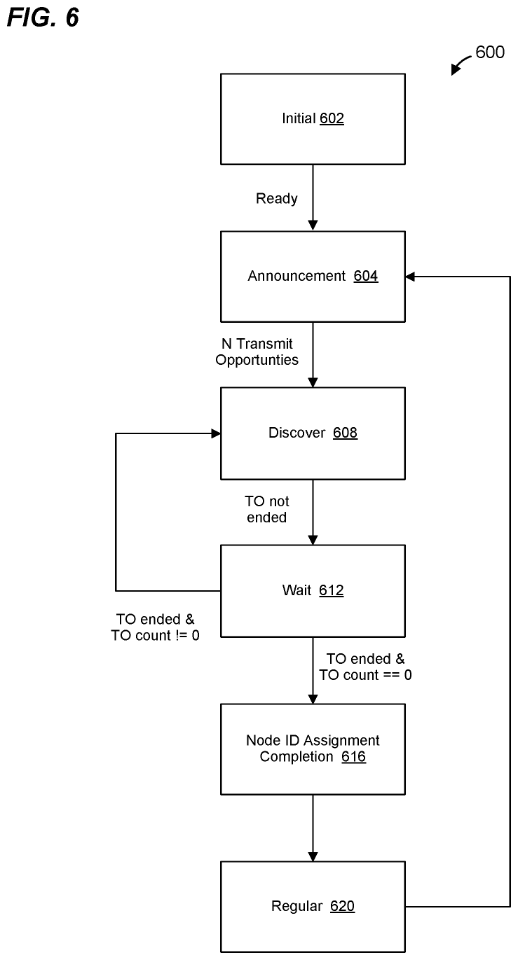

FIG. 6 is a simplified example state transition diagram 600 that the controller 360 of the coordinator 308 is configured to implement, according to an embodiment. In other embodiments, the controller 360 implements another suitable state transition diagram different than the state transition diagram 600. In other embodiments, a controller of another suitable network interface device different than the controller 308 implements the state transition diagram 600. FIG. 6 is described with reference to FIGS. 4A-D for case of explanation. In other embodiments, the state transition diagram 600 is implemented in connection with other suitable phases and time cycles different than those illustrated in FIGS. 4A-D.

The controller 360 begins in an initial state 602. For example, the controller 360 begins in the initial state 602 in connection with the coordinator 308 powering up, a reset of the coordinator 308, etc., in some embodiments.

When the controller 360 is ready to begin the node ID discovery procedure, the controller 360 transitions to an announcement state 604. In the announcement state 604, the controller 360 causes the coordinator 308 to transmit a beacon such as the beacon 432. Additionally, the controller 360 causes the coordinator 308 to provide the maximum number of transmit opportunities, such as the transmit opportunities 436, that, for example, corresponds to N, Q, etc. In an embodiment, providing the maximum number of transmit opportunities during the announcement state 604 comprises the controller 360 counting transmit opportunities during a time period, such as the announcement phase 404, until the maximum number of transmit opportunities have occurred.

In response to determining that the maximum number of transmit opportunities were provided, the controller 360 transitions to a node ID discovery state 608. In connection with transitioning from the announcement state 604 to the node ID discovery state 608, the controller 360 causes the coordinator 308 to transmit a beacon such as the beacon 448. Also in connection with transitioning from the announcement state 604 to the node ID discovery state 608, the controller 360 initializes a transmit opportunity (TO) count parameter to zero, e.g., maintained by a counter such at the counter 332. In an embodiment, also in connection with transitioning from the announcement state 604 to the node ID discovery state 608, the controller 360 initializes a follower count parameter to zero, e.g., maintained by another counter. In another embodiment, in connection with transitioning from the announcement state 604 to the node ID discovery state 608, the controller 360 additionally or alternatively initializes a follower record, e.g., like the data unit 500 of FIG. 5, to a first value, e.g., zero.

During the node ID discovery state 608, the controller 360 determines whether a transmission was received by the coordinator 308 in a current transmit opportunity, such as a transmit opportunity 452. In response to determining that a transmission was received during the current transmit opportunity, the controller 360 increments the follower count parameter, according to an embodiment. In another embodiment, the controller 360 additionally or alternatively sets a subunit of the follower record that corresponds to the current transmit opportunity (e.g., as indicated by the TO count parameter) in response to determining that a transmission was received. Otherwise, if no transmission is detected during the current transmit opportunity, the follower count parameter is not incremented, in an embodiment. Additionally or alternatively, if no transmission is detected during the current transmit opportunity, the follower record is not modified.

The controller 360 transitions to a wait state 612 in which the controller 360 waits until the current transmit opportunity ends. In an embodiment, during the wait state 612 or connection with transitioning to the wait state 612, the controller 360 increments the TO count parameter. The TO count parameter is incremented in a modulo N manner such that, when the TO count parameter is at N−1, incrementing the TO count parameter corresponds to setting the TO count parameter to 0, in an embodiment.

In response to i) the current transmit opportunity ending and ii) there being one or more additional transmit opportunities left in the node ID discovery phase (e.g., the TO count parameter is not equal to zero), the controller 360 transitions back to the discover state 608 in which the controller 360 determines whether a transmission is detected in the next transmit opportunity.

On the other hand, in response to i) the current transmit opportunity ending and ii) there being no more transmit opportunities left in the node ID discovery phase (e.g., the TO count parameter is at zero), the controller 360 transitions to a node ID assignment completion state 616. In the node ID assignment completion state 616, the controller 360 determines the number of followers in the communication network using i) the follower count parameter and/or ii) the follower record, and uses the determined number of followers to determine a number of transmit opportunities to provide during regular operation, in an embodiment. In another embodiment, the controller 360 determines the number of transmit opportunities to provide during regular operation using i) the follower count parameter and/or ii) the follower record, without first determining number of followers.

Then, the controller 360 transitions to a regular operation state 620 in which the controller 360 controls the coordinator 308 to operate according to time cycles such as the time cycles 420 of FIGS. 4A and 4D. For example, the controller 360 controls the coordinator 308 to provide, in each time cycle 420, a number of transmit opportunities that corresponds to the number of followers determined during the node ID assignment completion state 616.

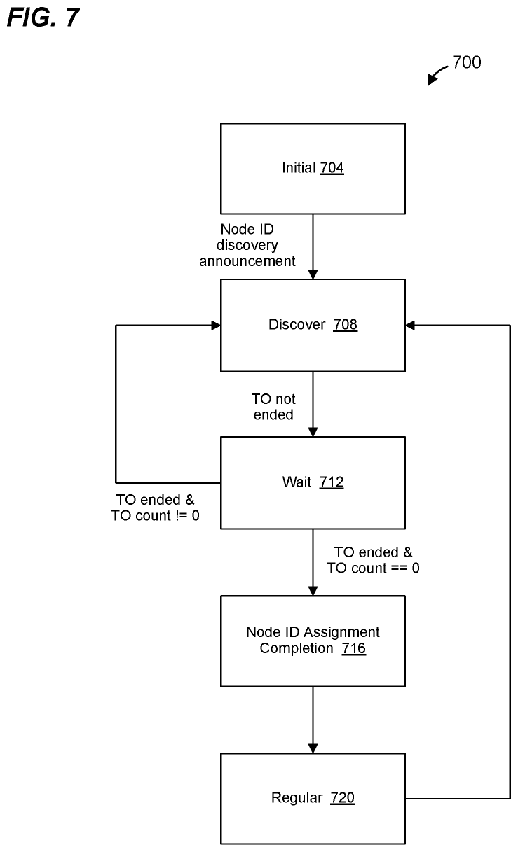

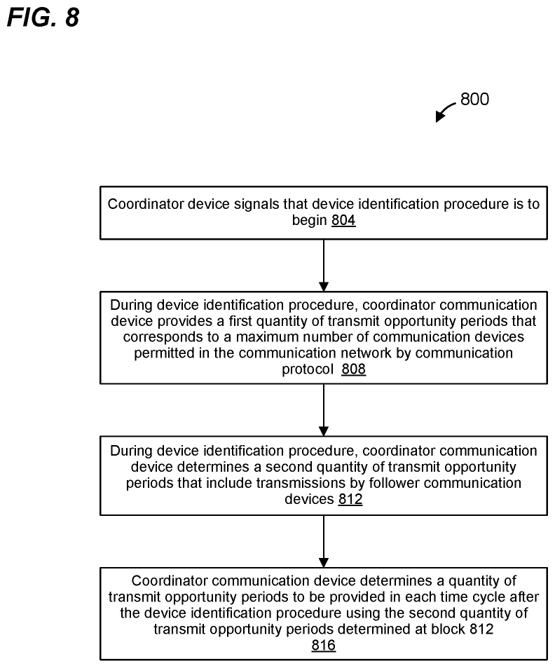

FIG. 7 is a simplified example state transition diagram 700 that the controller 364 of the follower 312 is configured to implement, according to an embodiment. In other embodiments, the controller 364 implements another suitable state transition diagram different than the state transition diagram 700. In other embodiments, a controller of another suitable network interface device different than the follower 312 implements the state transition diagram 700. FIG. 7 is described with reference to FIGS. 4A-D for ease of explanation. In other embodiments, the state transition diagram 700 is implemented in connection with other suitable phases and time cycles different than those illustrated in FIGS. 4A-D.

The controller 364 begins in an initial state 704. For example, the controller 364 begins in the initial state 704 in connection with the follower 312 powering up, a reset of the follower 312, etc., in some embodiments.

In the initial state 704, the controller 364 waits until the coordinator 308 announces a node ID discovery procedure is to begin, according to an embodiment. For example, the controller 364 counts a number of transmit opportunities after a beacon, e.g., using a counter such as the counter 336.

In response to determining that the coordinator 308 has announced node ID discovery procedure is to begin, the controller 364 transitions to a node ID discovery state 708. In connection with transitioning from the initial state 704 to the node ID discovery state 708, the controller 364 initializes a transmit opportunity (TO) count parameter to zero, e.g., maintained by a counter such at the counter 336. In an embodiment, also in connection with transitioning from the initial state 704 to the node ID discovery state 708, the controller 364 initializes a follower count parameter to zero, e.g., maintained by another counter such as the counter 364.

During the node ID discovery state 708, the controller 364 determines whether the current transmit opportunity, such as the such as a transmit opportunity 452, corresponds to the initial node ID of the follower 312. In response to determining that the current transmit opportunity does not correspond to the initial node ID of the follower 312, the controller 364 controls the follower 312 to remain silent during the current transmit opportunity. Additionally, the controller 364 determines whether a transmission was received by the follower 312 in the current transmit opportunity. In response to determining that a transmission was received during the current transmit opportunity, the controller 364 increments the follower count parameter, according to an embodiment. Otherwise, if no transmission is detected during the current transmit opportunity, the follower count parameter is not incremented, in an embodiment.

On the other hand, in response to determining that the current transmit opportunity corresponds to the initial node ID of the follower 312, the controller 364 controls the follower 312 to transmit during the current transmit opportunity. Additionally, the controller 364 sets a count of previous followers parameter to a current value of the follower count parameter. The count of previous followers parameter indicates a quantity of transmit opportunities, prior to the transmit opportunity corresponding to the initial node ID of the follower 312, in which other followers 312 transmitted. The count of previous followers parameter can be used to set the new node ID of the follower 312, as will be discussed below.

The controller 364 transitions to a wait state 712 in which the controller 364 waits until the current transmit opportunity ends. In an embodiment, during the wait state 712 or connection with transitioning to the wait state 712, the controller 364 increments the TO count parameter. The TO count parameter is incremented in a modulo N manner such that, when the TO count parameter is at N−1, incrementing the TO count parameter corresponds to setting the TO count parameter to 0, in an embodiment.

In response to i) the current transmit opportunity ending and ii) there being one or more additional transmit opportunities left in the node ID discovery phase (e.g., the TO count parameter is not equal to zero), the controller 364 transitions back to the discover state 708.

On the other hand, in response to i) the current transmit opportunity ending and ii) there being no more transmit opportunities left in the node ID discovery phase (e.g., the TO count parameter is at zero), the controller 364 transitions to a node ID assignment completion state 716. In the node ID assignment completion state 716, the controller 364 determines the new node ID using the count of previous followers parameter. As an example, the new node ID is set to X+1, where X is a value of the count of previous followers parameter, in an embodiment.

Also in the node ID assignment completion state 716, the controller 364 determines a number of followers in the communication network using the follower count parameter. As an example, the number of followers is set to Y+1, where Y is a value of the follower count parameter, in an embodiment.

Then, the controller 360 transitions to a regular operation state 720 in which the controller 364 controls the follower 312 to operate according to time cycles such as the time cycles 420 of FIGS. 4A and 4D. For example, the controller 364 controls the follower 312 to determine a transmit opportunity 468 for the follower 312 that corresponds to the new node ID of the follower 312.

FIG. 8 is a flow diagram of an example method 800 for providing transmission opportunities in a communication network, according to an embodiment. The method 800 is performed in a communication network that operates according to a communication protocol that defines repeating time cycles and specifies that each of multiple communication devices is provided a respective transmit opportunity in each time cycle, according to an embodiment.

The method 800 is implemented by a network interface device such as the coordinator 308 of FIG. 3A, according to an embodiment, and the method 800 is described with reference to FIG. 3A for case of explanation. In other embodiments, the method 800 is implemented by another suitable network interface device different than the coordinator 308. In other embodiments, the coordinator 308 implements another suitable method for providing transmission opportunities different than the method 800.

FIG. 8 is described with reference to FIGS. 4A-D for case of explanation. In other embodiments, the method 800 is performed in connection with other suitable phases and time cycles different than those illustrated in FIGS. 4A-D.

At block 804, the network interface device signals to other communication devices in the communication network that a device identification procedure is to begin. In an embodiment, the coordinator 308 signals to one or more followers 312 that the device identification procedure is to begin. The network interface device signals to the other communication devices that the device identification procedure is to begin using a technique such as described above, e.g., with reference to FIGS. 4A-B, in an embodiment. In other embodiments, the network interface device signals to the other communication devices that the device identification procedure is to begin using another suitable technique, such as transmitting to follower devices a packet that indicates the device identification procedure is to begin.

At block 808, during the device identification procedure, the network interface device (e.g., the coordinator 308) provides to other devices in the network (e.g., the followers 312) a first quantity of transmit opportunity periods that corresponds to a maximum number of communication devices (e.g., N, Q, etc.). For example, the coordinator 308 provides N transmit opportunity periods 452 during the node ID discovery phase 408. As another example, the coordinator 308 provides Q transmit opportunity periods 452 during the node ID discovery phase 408.

At block 812, during the device identification procedure, the network interface device (e.g., the coordinator 308) determines a second quantity of second transmit opportunity periods that include transmissions by follower communication devices. For example, the coordinator 308 counts a number of transmit opportunity periods 452 in which a transmission from a respective follower device is received.

At block 816, the network interface device determines (e.g., the coordinator 308 determines), using the second quantity of second transmit opportunity periods determined at block 812, a quantity of transmit opportunities to be provided in each time cycle after the device identification procedure.

In an embodiment, the method 800 further comprises: the network interface device provides (e.g., the coordinator 308 provides) to other devices in the network (e.g., the followers 312) the quantity of transmit opportunity periods determined at block 816 in each of a plurality of time cycles that occur after the device identification procedure. For example, the coordinator 308 provides the quantity of transmit opportunity periods 468 determined at block 816 during each of the time cycles 420.

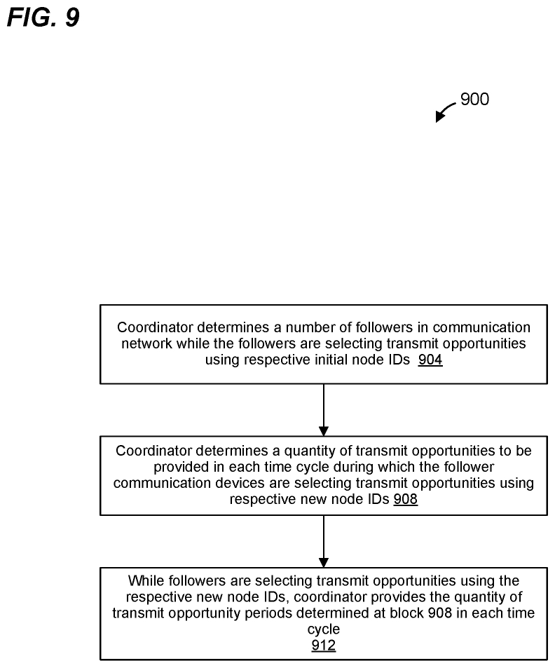

FIG. 9 is a flow diagram of another example method 900 for providing transmission opportunities in a communication network, according to another embodiment. The method 900 is performed in a communication network that operates according to a communication protocol that defines repeating time cycles and specifies that each of multiple communication devices is provided a respective transmit opportunity in each time cycle, according to an embodiment.

The method 900 is implemented by a network interface device such as the coordinator 308 of FIG. 3A, according to an embodiment, and the method 900 is described with reference to FIG. 3A for ease of explanation. In other embodiments, the method 900 is implemented by another suitable network interface device different than the coordinator 308. In other embodiments, the coordinator 308 implements another suitable method for providing transmission opportunities different than the method 900.

FIG. 9 is described with reference to FIGS. 4A-D for case of explanation. In other embodiments, the method 900 is performed in connection with other suitable phases and time cycles different than those illustrated in FIGS. 4A-D.

At block 904, a coordinator determines a number of followers in the communication network while the followers are selecting transmit opportunities using respective initial node IDs. For example, the coordinator 308 determines a number of followers 312 in the communication network 300 while the followers 312 are selecting transmit opportunities using respective initial node IDs. In an embodiment, the coordinator determines the number of followers in the communication network based on counting a number of transmit opportunity periods 452 in which a transmission from a respective follower device is received while the followers 312 are selecting transmit opportunities using respective initial node IDs.

At block 908, the coordinator determines a quantity of transmit opportunities to be provided in each time cycle during which the follower communication devices are selecting transmit opportunities using respective new node IDs. For example, the coordinator 308 determines a quantity of transmit opportunities 468 to be provided in each time cycle 420 while the followers 312 are selecting transmit opportunities using respective new node IDs. In an embodiment, determining the quantity of transmit opportunities at block 908 includes determining the quantity of transmit opportunities using the number of follower communication devices determined at block 904.

At block 912, while the followers are selecting transmit opportunities using the respective new node IDs, the coordinator provides the quantity of transmit opportunity periods determined at block 908 in each time cycle. For example, the coordinator 308 provides quantity of transmit opportunities 468 determined at block 908 each time cycle 420. In an embodiment, providing the quantity of transmit opportunity periods in each time cycle at block 912 comprises, in connection with each time cycle: transmitting, by the coordinator, a first beacon at a beginning of the time cycle; and transmitting, by the coordinator, a second beacon after an end of the time cycle so that a time duration from an end of the first beacon and a beginning of the second beacon corresponds to the quantity of transmit opportunity periods.

In another embodiment, providing the quantity of transmit opportunity periods in each time cycle at block 912 comprises providing the quantity of first transmit opportunity periods in each first time cycle; and wherein determining number of follower communication devices at block 904 comprises: providing, by the coordinator, a predetermined quantity of second transmit opportunity periods during a second time cycle, wherein the predetermined quantity of second transmit opportunity periods corresponds to an expected maximum quantity of follower communication devices in the communication network; determining, at the coordinator, a quantity of second transmit opportunity periods, during the second time cycle, that include transmissions by one or more follower communication devices; and determining, at the coordinator, the number of follower communication devices using the quantity of second transmit opportunity periods that include transmissions by one or more follower communication devices.

In an embodiment, the predetermined quantity of second transmit opportunity periods corresponds to a maximum number of communication devices permitted in the communication network by the communication protocol.

In an embodiment, each follower communication device is configured to transmit during a respective second transmit opportunity period that corresponds to the respective initial node ID of the follower communication device.

In another embodiment, providing the predetermined quantity of second transmit opportunity periods during the second time cycle comprises: transmitting, by the coordinator, a first beacon at a beginning of the second time cycle; and transmitting, by the coordinator, a second beacon after an end of the second time cycle so that a time duration from an end of the first beacon and a beginning of the second beacon corresponds to the predetermined quantity of second transmit opportunity periods.

In another embodiment, providing the quantity of first transmit opportunity periods in each first time cycle comprises, in connection with each first time cycle: transmitting, by the coordinator, a first beacon at a beginning of the first time cycle; and transmitting, by the coordinator, a second beacon after an end of the first time cycle so that a time duration from an end of the first beacon and a beginning of the second beacon corresponds to the quantity of first transmit opportunity periods.

In another embodiment, the method 900 further comprises: signaling, by the coordinator, to one or more followers that a device identification procedure is to begin; wherein determining the number of followers at block 904 is performed during the device identification procedure; and wherein the followers select transmit opportunities using the respective new device identifiers at block 912 after the device identification procedure.

In another embodiment, signaling that the device identification procedure is to begin comprises providing, by the coordinator, a predetermined quantity of transmit opportunity periods during a time cycle that precedes the device identification procedure.

In an embodiment, the predetermined quantity of transmit opportunity periods corresponds to a maximum number of communication devices permitted in the communication network by the communication protocol.

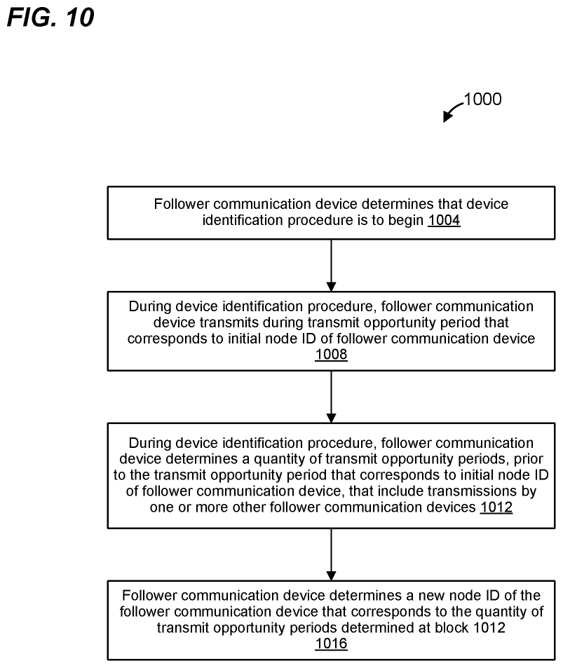

FIG. 10 is a flow diagram of an example method 1000 for determining an identifier of a communication device in a communication network, according to an embodiment. The method 1000 is performed in a communication network that operates according to a communication protocol that defines repeating time cycles and specifies that each of multiple communication devices is provided a respective transmit opportunity in each time cycle, according to an embodiment.

The method 1000 is implemented by a network interface device such as the follower 312 of FIG. 3A, according to an embodiment, and the method 1000 is described with reference to FIG. 3A for case of explanation. In other embodiments, the method 1000 is implemented by another suitable network interface device different than the follower 312. In other embodiments, the follower 312 implements another suitable method for determining an identifier of a communication device different than the method 1000.

FIG. 10 is described with reference to FIGS. 4A-D for case of explanation. In other embodiments, the method 1000 is performed in connection with other suitable phases and time cycles different than those illustrated in FIGS. 4A-D.

At block 1004, the network interface device determines that a device identification procedure is to begin. In an embodiment, the follower 312 determines that the device identification procedure is to begin based on a signal from the coordinator 308. The network interface device determines that the device identification procedure is to begin using a technique such as described above, e.g., with reference to FIGS. 4A-B, in an embodiment. In other embodiments, the network interface device determines that the device identification procedure is to begin using another suitable technique, such as in response to receiving a packet from the coordinator 308 that indicates the device identification procedure is to begin.

At block 1008, during the device identification procedure, the network interface device transmits during a transmit opportunity period that corresponds to an initial identifier of the network interface device. For example, during the node ID discovery phase 408, the follower 312 transmits during a transmit opportunity 452 that corresponds to the follower 312.

At block 1012, during the device identification procedure, the network interface device determines a quantity of transmit opportunity periods, prior to the transmit opportunity period that corresponds to initial identifier of network interface device, that include transmissions by one or more other communication devices. For example, during the node ID discovery phase 408, the follower 312 determines a quantity of transmit opportunity periods 452, prior to the transmit opportunity period 452 that corresponds to initial identifier of the follower 312, that include transmissions by one or more other followers 312.

At block 1016, the network interface device determines a new identifier for the network interface device that corresponds to the quantity of transmit opportunity periods determined at block 1012. For example, the follower 312 determines a new node ID for the follower 312 using the quantity of transmit opportunity periods determined at block 1012.

In an embodiment, the method 1000 further comprises: during each of multiple time cycles after the device identification procedure, the network interface device determines (e.g., the follower 312 determines) which transmit opportunity period corresponds to the network interface device using the new identifier. For example, during each of multiple time cycles 420, the follower 312 uses the new node ID to determine the transmit opportunity 468 that corresponds to the follower 312.

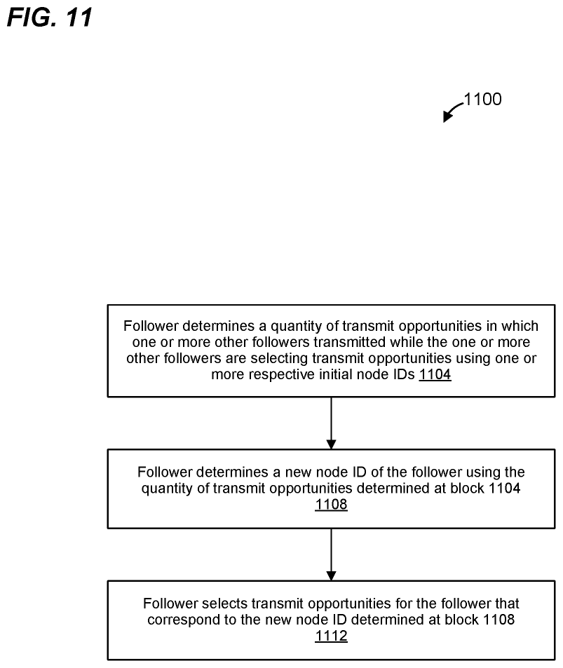

FIG. 11 is a flow diagram of another example method 1100 for determining an identifier of a communication device in a communication network, according to another embodiment. The method 1100 is performed in a communication network that operates according to a communication protocol that defines repeating time cycles and specifies that each of multiple communication devices is provided a respective transmit opportunity in each time cycle, according to an embodiment.

The method 1100 is implemented by a network interface device such as the follower 312 of FIG. 3A, according to an embodiment, and the method 1100 is described with reference to FIG. 3A for ease of explanation. In other embodiments, the method 1100 is implemented by another suitable network interface device different than the follower 312. In other embodiments, the follower 312 implements another suitable method for determining an identifier of a communication device different than the method 1100.

FIG. 11 is described with reference to FIGS. 4A-D for ease of explanation. In other embodiments, the method 1100 is performed in connection with other suitable phases and time cycles different than those illustrated in FIGS. 4A-D.

At block 1104, the follower determines a quantity of transmit opportunities in which one or more other followers in the communication network transmitted while the one or more other followers are selecting transmit opportunities using one or more respective initial node IDs. For example, the follower 312 determines the quantity of transmit opportunities in the which one or more other followers 312 transmitted while the one or more other followers are selecting transmit opportunities using one or more respective initial node IDs.

At block 1108, the follower determines a new node ID of the follower communication device using the quantity of transmit opportunities determined at block 1104. For example, the follower 312 determines the new node ID.

At block 1112, after determining the new node ID at block 1108, the follower selects transmit opportunities for the follower that correspond to the new node ID determined at block 1108. For example, the follower 312 selects transmit opportunities at block 1112.

In another embodiment, the method 1100 further comprises, prior to the follower selecting (block 1112) transmit opportunities with the new node ID, the follower transmits during a transmit opportunity period that corresponds to the initial node ID of the follower.

In another embodiment, determining the quantity of transmit opportunities at block 1104 comprises the follower determining the quantity of transmit opportunities during a first time cycle in which one or more other follower communication devices in the communication network transmitted. In an embodiment, the method 1100 further comprises the follower determining that a device identification procedure is to begin in connection with a second time cycle that precedes the first time cycle; wherein the device identification procedure corresponds to the first time cycle.

In another embodiment, determining the quantity of transmit opportunities at block 1104 comprises the follower determining a quantity of first transmit opportunities during the first time cycle in which one or more other follower communication devices in the communication network transmitted; and determining that the device identification procedure is to begin comprises the follower determining that the second time cycle includes a predetermined number of second transmit opportunity periods.

In another embodiment, determining the quantity of transmit opportunities during the first time cycle comprises the follower determining a quantity of transmit opportunities during the first time cycle, and prior to a transmit opportunity of the follower within the first time cycle, in which one or more other followers in the communication network transmitted; and determining the new identifier at block 1108 comprises the follower using the quantity of transmit opportunities during the first time cycle, and prior to the transmit opportunity of the follower within the first time cycle, in which one or more other followers in the communication network transmitted.

In another embodiment, the first time cycle begins with a beacon from the coordinator communication device; and determining the quantity of transmit opportunities during the first time cycle, and prior to the transmit opportunity of the follower communication device within the first time cycle, in which one or more other follower communication devices in the communication network transmitted comprises the follower counting a number of transmit opportunities i) after the beacon, and ii) prior to a transmit opportunity that corresponds to the initial device identifier of the follower communication device.

In some scenarios, errors may occur in device identification procedures such as described above. For example, the coordinator 308 and/or one or more other followers 312 do not detect a transmission by a follower 312 during the device identification procedure, and as a result the coordinator 308 does not provide enough transmit opportunities during the regular operation period 412 and/or multiple followers 312 choose a same new node ID. As another example, a follower device 312 falsely detects a transmission during the device identification procedure, and as a result the coordinator 308 does not provide enough transmit opportunities during the regular operation period 412 and/or multiple followers 312 choose a same new node ID.

In some embodiments, the coordinator 308 provides one or more additional transmit opportunities during each of multiple time cycles, where the one or more additional transmit opportunities are reserved for followers 312 to signal an error, such as an error corresponding to a device identification procedure such as described above.

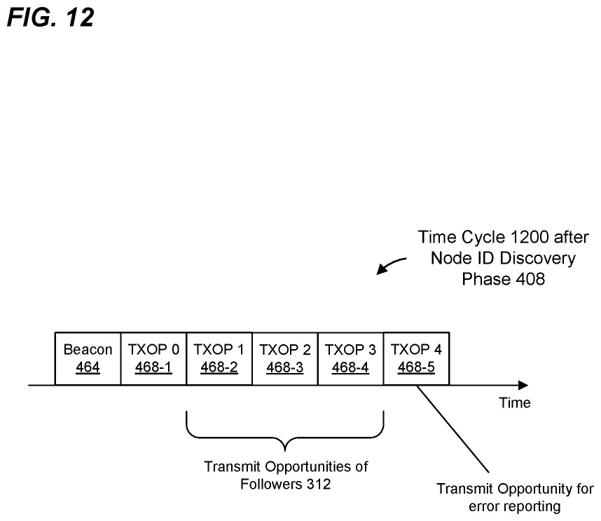

FIG. 12 is a timing diagram illustrating an example time cycle 1200 during a regular operation phase after a node ID discovery operation, according to an embodiment. FIG. 12 is described with reference to FIGS. 3, 4A, and 4D for case of explanation. In other embodiments, the example time cycle 1200 is implemented in another suitable communication network different than the communication network 300, and/or is implemented in connection with other suitable phases and time cycles different than those illustrated in FIGS. 4A-D.

The time cycle 1200 occurs during the regular operation phase 412 after the node ID discovery phase 408 (FIGS. 4A, 4D), according to an embodiment.

The coordinator 308 provides an additional transmit opportunity 468-5 that is reserved for followers 312 to signal an error, such as an error corresponding to a device identification procedure such as described above. The coordinator 308 provides the additional transmit opportunity 468-5 after providing transmit opportunities 468 to the followers 312 known to the coordinator 308. In an embodiment, the coordinator sets the maximum node ID parameter 316 so that the coordinator 308 will provide the additional transmit opportunity 468-5 after providing the transmit opportunities 468 to the followers 312 known to the coordinator 308.

In response to a follower 312 detecting an error, such as an error corresponding to a device identification procedure such as described above, the follower 312 transmits during the additional transmit opportunity 468-5 to signal to the coordinator 308 that the follower 312 has detected an error. In an embodiments, the transmission is a suitable transmission, such as a COMMIT signal, a packet, etc.

In response to the coordinator 308 detecting a transmission during the additional transmit opportunity 468-5, the coordinator 308 determines that an error condition exists. In response to determining that the error condition exists, the coordinator 308 takes an appropriate action to address the error condition. As an illustrative example, the coordinator 308 repeats the device identification procedure, according to an embodiment.

In I other embodiments, the additional transmit opportunity 468-5 is provided in another suitable location within the time cycle 1200. For example, the additional transmit opportunity 468-5 is provided between the beacon 464 and the transmit opportunity 468-1. As another example, the additional transmit opportunity 468-5 is provided between the transmit opportunity 468-1 and the transmit opportunity 468-2. In embodiments in which the additional transmit opportunity 468-5 is located prior to an end of the time cycle 1200, the follower devices 312 are configured to select new node IDs in a manner that leaves the node ID corresponding to the additional transmit opportunity 468-5 unused.

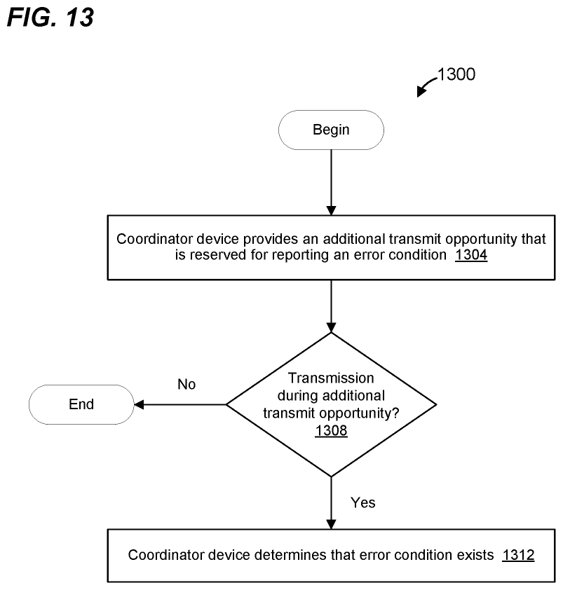

FIG. 13 is a flow diagram of an example method 1300 for error handling in a communication network, according to an embodiment. The method 1300 is performed in a communication network that operates according to a communication protocol that defines repeating time cycles and specifies that each of multiple communication devices is provided a respective transmit opportunity in each time cycle, according to an embodiment.

The method 1300 is implemented by a network interface device such as the coordinator 308 of FIG. 3A, according to an embodiment, and the method 1300 is described with reference to FIG. 3A for ease of explanation. In other embodiments, the method 1300 is implemented by another suitable network interface device different than the coordinator 308. In other embodiments, the coordinator 308 implements another suitable method for error handling different than the method 1300.

FIG. 13 is described with reference to FIGS. 4A-D and 10 for ease of explanation. In other embodiments, the method 1300 is performed in connection with other suitable phases and time cycles different than those illustrated in FIGS. 4A-D and 10.

In an embodiment, the method 1300 is performed in each of multiple time cycles defined by the communication protocol.

At block 1304, during each of at least some of the time cycles, a network interface device provides an additional transmit opportunity that is reserved for one or more communication devices to signal an error condition. For example, the coordinator 308 provides (e.g., the controller 360 controls the coordinator 308 to provide) an additional transmit opportunity that is reserved for followers 312 to signal error conditions. The coordinator 308 provides the additional transmit opportunity 468-5 during the time cycle 1200, as an illustrative example.

At block 1308, the network interface device determines whether a transmission is received during the additional time cycle. For example, the coordinator 308 determines (e.g., the controller 360 determines) whether a transmission, such as a COMMIT signal, a packet, or another suitable transmission, is received by the coordinator 308 during the additional time cycle.

In response to determining at block 1308 that no transmission was received during the additional time cycle, the flow ends. On the other hand, in response to determining at block 1308 that a transmission was received during the additional time cycle, the flow proceeds to block 1312. At block 1312, the network interface device determines that an error condition exists in the communication network. For example, the coordinator 308 determines (e.g., the controller 360 determines) that that an error condition exists in the communication network.

In an embodiment, the method 1300 further comprises: in response to determining at block 1312 that the error condition exists, the network interface device takes an appropriate action to address the error condition. As an illustrative example, the coordinator 308 repeats (e.g., the controller 360 controls the coordinator 308 to repeat) the device identification procedure, according to an embodiment.

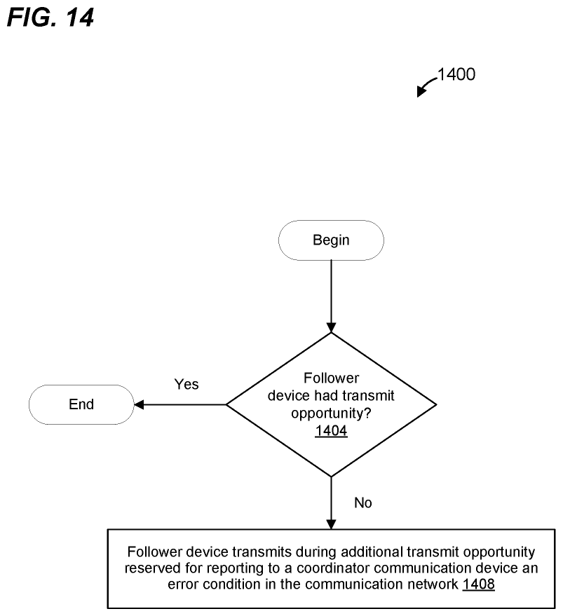

FIG. 14 is a flow diagram of another example method 1400 for error handling in a communication network, according to another embodiment. The method 1400 is performed in a communication network that operates according to a communication protocol that defines repeating time cycles and specifies that each of multiple communication devices is provided a respective transmit opportunity in each time cycle, according to an embodiment.

The method 1400 is implemented by a network interface device such as the follower 312 of FIG. 3A, according to an embodiment, and the method 1400 is described with reference to FIG. 3A for case of explanation. In other embodiments, the method 1400 is implemented by another suitable network interface device different than the follower 312. In other embodiments, the follower 312 implements another suitable method for error handling different than the method 1400.

FIG. 14 is described with reference to FIGS. 4A-D and 10 for ease of explanation. In other embodiments, the method 1400 is performed in connection with other suitable phases and time cycles different than those illustrated in FIGS. 4A-D and 10.

In an embodiment, the method 1400 is performed in each of multiple time cycles defined by the communication protocol.

At block 1404, a network interface device determines that an error condition exists in the communication network. For example, the network interface device determines that the network interface device was not provided a transmit opportunity during a first time cycle. For example, the follower 312 determines that the follower 312 was not provided a transmit opportunity during the time cycle 1200 or another time cycle previous to the time cycle 1200.

Determining that the follower 312 was not provided a transmit opportunity during the first time cycle comprises determining that the coordinator 308 transmitted a subsequent beacon prior to a transmit opportunity being provided for the follower 312 during the first time cycle, in an embodiment. Determining that the follower 312 was not provided a transmit opportunity during the first time cycle comprises determining that the coordinator 308 did not receive a previous transmission by the follower 312, in an embodiment. For example, if the follower 312 does not receive an acknowledgement from the coordinator 308 of a previous transmission by the follower 312 (e.g., in a time cycle previous to the first time cycle), this may indicate that there was a collision with another transmission by another follower 312, i.e., another follower 312 is attempting to use the same transmit opportunity, i.e., the follower 312 was not provided with its own transmit opportunity.

In response to determining at block 1404 that the follower device was provided a transmit opportunity during the first time cycle, the flow ends. On the other hand, in response to determining at block 1404 that the follower device was not provided a transmit opportunity during the first time cycle, the flow proceeds to block 1408.

At block 1408, the network interface device transmits during an additional transmit opportunity of the first time cycle or a subsequent time cycle that is reserved for reporting to a coordinator communication device an error condition in the communication network. Transmitting during the additional transmit opportunity comprises transmitting a suitable signal such as a COMMIT signal, a packet, or another suitable transmission.

Embodiment 1: A method for providing transmission opportunities in a communication network that operates according to a communication protocol, the communication protocol defining repeating time cycles, wherein the communication protocol specifies that each of multiple communication devices is provided a respective transmit opportunity in each time cycle, the method comprising: determining, at a coordinator communication device, a number of follower communication devices in the communication network while the follower communication devices are selecting transmit opportunities using respective initial device identifiers; determining, at the coordinator communication device, a quantity of transmit opportunities to be provided in each time cycle during which the follower communication devices are selecting transmit opportunities using respective new device identifiers, including determining the quantity of transmit opportunities using the number of follower communication devices; and while the follower communication devices are selecting transmit opportunities using the respective new device identifiers, providing, by the coordinator communication device, the quantity of transmit opportunity periods in each time cycle.

Embodiment 2: The method of embodiment 1, providing the quantity of transmit opportunity periods in each time cycle comprises the providing the quantity of first transmit opportunity periods in each first time cycle, and wherein determining number of follower communication devices comprises: providing, by the coordinator communication device, a predetermined quantity of second transmit opportunity periods during a second time cycle, wherein the predetermined quantity of second transmit opportunity periods corresponds to an expected maximum quantity of follower communication devices in the communication network; determining, at the coordinator communication device, a quantity of second transmit opportunity periods, during the second time cycle, that include transmissions by one or more follower communication devices; and determining, at the coordinator communication device, the number of follower communication devices using the quantity of second transmit opportunity periods that include transmissions by one or more follower communication devices.

Embodiment 3: The method of embodiment 2, wherein predetermined quantity of second transmit opportunity periods corresponds to a maximum number of communication devices permitted in the communication network by the communication protocol.

Embodiment 4: The method of either of embodiments 2 or 3, wherein each follower communication device is configured to transmit during a respective second transmit opportunity period that corresponds to the respective initial device identifier of the follower communication device.

Embodiment 5: The method of any of embodiments 2-4, wherein providing the predetermined quantity of second transmit opportunity periods during the second time cycle comprises: transmitting, by the coordinator communication device, a first beacon at a beginning of the second time cycle; and transmitting, by the coordinator communication device, a second beacon after an end of the second time cycle so that a time duration from an end of the first beacon and a beginning of the second beacon corresponds to the predetermined quantity of second transmit opportunity periods.

Embodiment 6: The method of any of embodiments 2-5, wherein providing the quantity of first transmit opportunity periods in each first time cycle comprises, in connection with each first time cycle: transmitting, by the coordinator communication device, a first beacon at a beginning of the first time cycle; and transmitting, by the coordinator communication device, a second beacon after an end of the first time cycle so that a time duration from an end of the first beacon and a beginning of the second beacon corresponds to the quantity of first transmit opportunity periods.

Embodiment 7: The method of any of embodiments 1-6, wherein providing the quantity of transmit opportunity periods in each time cycle comprises, in connection with each time cycle: transmitting, by the coordinator communication device, a first beacon at a beginning of the time cycle; and transmitting, by the coordinator communication device, a second beacon after an end of the time cycle so that a time duration from an end of the first beacon and a beginning of the second beacon corresponds to the quantity of transmit opportunity periods.

Embodiment 8: The method of any of embodiments 1-7, further comprising: signaling, by the coordinator communication device, to one or more follower communication devices that a device identification procedure is to begin; wherein determining the number of follower communication devices in the communication network while the follower communication devices are selecting transmit opportunities using respective initial device identifiers is performed in connection with the device identification procedure; and wherein the follower communication devices select transmit opportunities using the respective new device identifiers after the device identification procedure.

Embodiment 9: The method of embodiment 8, wherein signaling that the device identification procedure is to begin comprises: providing, by the coordinator communication device, a predetermined quantity of transmit opportunity periods during a time cycle that precedes the device identification procedure.

Embodiment 10: The method of embodiment 9, wherein the predetermined quantity of transmit opportunity periods corresponds to a maximum number of communication devices permitted in the communication network by the communication protocol.

Embodiment 11: A network interface device for communicating in a communication network that operates according to a communication protocol, the communication protocol defining repeating time cycles, wherein the communication protocol specifies that each of multiple communication devices is provided a respective transmit opportunity in each time cycle, the network interface device being configured to operate as a coordinator communication device and comprising: receiver circuitry; transmit circuitry; and controller circuitry. The controller circuitry is configured to: determine a number of follower communication devices in the communication network while the follower communication devices are selecting transmit opportunities using respective initial device identifiers; determine a quantity of transmit opportunities to be provided in each time cycle during which the follower communication devices are selecting transmit opportunities using respective new device identifiers, including determining the quantity of transmit opportunities using the number of follower communication devices; and while the follower communication devices are selecting transmit opportunities using the respective new device identifiers, provide the quantity of transmit opportunity periods in each time cycle.

Embodiment 12: The network interface device of embodiment 11, where the controller circuitry is configured to: provide the quantity of first transmit opportunity periods in each first time cycle; and determine the number of follower communication devices at least by: providing a predetermined quantity of second transmit opportunity periods during a second time cycle, wherein the predetermined quantity of second transmit opportunity periods corresponds to an expected maximum quantity of follower communication devices in the communication network, determining a quantity of second transmit opportunity periods, during the second time cycle, that include transmissions by one or more follower communication devices, and determining the number of follower communication devices using the quantity of second transmit opportunity periods that include transmissions by one or more follower communication devices.

Embodiment 13: The network interface device of embodiment 12, wherein predetermined quantity of second transmit opportunity periods corresponds to a maximum number of communication devices permitted in the communication network by the communication protocol.

Embodiment 14: The network interface device of either of embodiments 12 or 13, wherein each follower communication device is configured to transmit during a respective second transmit opportunity period that corresponds to the respective initial device identifier of the follower communication device.

Embodiment 15: The network interface device of any of embodiments 12-14, wherein the controller circuitry is configured to provide the predetermined quantity of second transmit opportunity periods during the second time cycle at least by: controlling the transmit circuitry to transmit a first beacon at a beginning of the second time cycle; and controlling the transmit circuitry to transmit a second beacon after an end of the second time cycle so that a time duration from an end of the first beacon and a beginning of the second beacon corresponds to the predetermined quantity of second transmit opportunity periods.

Embodiment 16: The network interface device of any of embodiments 12-15, wherein the controller circuitry is configured to provide the quantity of first transmit opportunity periods in each first time cycle at least by, in connection with each first time cycle: controlling the transmit circuitry to transmit a first beacon at a beginning of the first time cycle; and controlling the transmit circuitry to transmit a second beacon after an end of the first time cycle so that a time duration from an end of the first beacon and a beginning of the second beacon corresponds to the quantity of first transmit opportunity periods.

Embodiment 17: The network interface device of any of embodiments 11-16, wherein the controller circuitry is configured to provide the quantity of transmit opportunity periods in each time cycle at least by, in connection with each time cycle: controlling the transmit circuitry to transmit a first beacon at a beginning of the time cycle; and controlling the transmit circuitry to transmit a second beacon after an end of the time cycle so that a time duration from an end of the first beacon and a beginning of the second beacon corresponds to the quantity of transmit opportunity periods.

Embodiment 18: The network interface device of any of embodiments 11-17, wherein the controller circuitry is further configured to: controlling the transmit circuitry to signal to one or more follower devices that a device identification procedure is to begin; and determine the number of follower communication devices in the communication network while the follower communication devices are selecting transmit opportunities using respective initial device identifiers in connection with the device identification procedure; wherein the follower communication devices select transmit opportunities using the respective new device identifiers after the device identification procedure.

Embodiment 19: The network interface device of embodiment 18, wherein the controller circuitry is further configured to signal that the device identification procedure is to begin at least by: providing a predetermined quantity of transmit opportunity periods during a time cycle that precedes the device identification procedure.

Embodiment 20: The network interface device of embodiment 19, wherein the predetermined quantity of transmit opportunity periods corresponds to a maximum number of communication devices permitted in the communication network by the communication protocol.

Embodiment 21: A method for determining an identifier for a communication device in a communication network that operates according to a communication protocol, the communication protocol defining repeating time cycles, wherein the communication protocol specifies that each of multiple communication devices is provided a respective transmit opportunity in each time cycle, the method comprising: determining, at a follower communication device, a quantity of transmit opportunities in which one or more other follower communication devices in the communication network transmitted while the one or more other follower communication devices are selecting transmit opportunities using one or more respective initial device identifiers; determining, at the follower communication device, a new identifier of the follower communication device using the quantity of transmit opportunities in which the one or more other follower communication devices in the communication network transmitted; and after determining the new identifier of the follower communication device, selecting, by the follower communication device, transmit opportunities for the follower communication device that correspond to the new device identifier.

Embodiment 22: The method of embodiment 21, further comprising, prior to determining the new identifier of the follower communication device: transmitting, by the follower communication device, during a transmit opportunity period that corresponds to an initial identifier of the follower communication device.

Embodiment 23: The method of either of embodiments 21 or 22, wherein determining the quantity of transmit opportunities in which one or more other follower communication devices in the communication network transmitted while the one or more other follower communication devices are selecting transmit opportunities using one or more respective initial device identifiers comprises: determining the quantity of transmit opportunities during a first time cycle in which one or more other follower communication devices in the communication network transmitted.

Embodiment 24: The method of embodiment 23, further comprising: determining, at the follower communication device, that a device identification procedure is to begin in connection with a second time cycle that precedes the first time cycle; wherein the device identification procedure corresponds to the first time cycle.

Embodiment 25: The method of embodiment 24, wherein: determining the quantity of transmit opportunities during the first time cycle comprises determining a quantity of first transmit opportunities during the first time cycle in which one or more other follower communication devices in the communication network transmitted; and determining that the device identification procedure is to begin comprises determining, at the follower communication device, that the second time cycle includes a predetermined number of second transmit opportunity periods.

Embodiment 26: The method of any of embodiments 21-25, wherein: determining the quantity of transmit opportunities during the first time cycle comprises determining a quantity of transmit opportunities during the first time cycle, and prior to a transmit opportunity of the follower communication device within the first time cycle, in which one or more other follower communication devices in the communication network transmitted; and determining the new identifier of the follower communication device comprises using the quantity of transmit opportunities during the first time cycle, and prior to the transmit opportunity of the follower communication device within the first time cycle, in which one or more other follower communication devices in the communication network transmitted.

Embodiment 27: The method of embodiment 26, wherein: the first time cycle begins with a beacon from the coordinator communication device; and determining the quantity of transmit opportunities during the first time cycle, and prior to the transmit opportunity of the follower communication device within the first time cycle, in which one or more other follower communication devices in the communication network transmitted comprises counting, by the follower communication device, a number of transmit opportunities i) after the beacon, and ii) prior to a transmit opportunity that corresponds to the initial device identifier of the follower communication device.

Embodiment 28: A network interface device for communicating in a communication network that operates according to a communication protocol, the communication protocol defining repeating time cycles, wherein the communication protocol specifies that each of multiple communication devices is provided a respective transmit opportunity in each time cycle, the network interface device being configured to operate as a follower communication device and comprising: receiver circuitry; transmit circuitry; and controller circuitry. The controller circuitry is configured to: determine a quantity of transmit opportunities in which one or more other follower communication devices in the communication network transmitted while the one or more other follower communication devices are selecting transmit opportunities using one or more respective initial device identifiers; determine a new identifier of the follower communication device using the quantity of transmit opportunities in which the one or more other follower communication devices in the communication network transmitted; and after determining the new identifier of the follower communication device, select transmit opportunities for the follower communication device that correspond to the new device identifier.

Embodiment 29: The network interface device of embodiment 28, wherein the controller circuitry is further configured to, prior to determining the new identifier of the follower communication device: control the transmit circuitry to transmit during a transmit opportunity period that corresponds to an initial identifier of the follower communication device.

Embodiment 30: The network interface device of either of embodiments 28 or 29, wherein the controller circuitry is further configured to determine the quantity of transmit opportunities in which one or more other follower communication devices in the communication network transmitted while the one or more other follower communication devices are selecting transmit opportunities using one or more respective initial device identifiers at least by: determining the quantity of transmit opportunities during a first time cycle in which one or more other follower communication devices in the communication network transmitted.

Embodiment 31: The network interface device of embodiment 30, wherein the controller circuitry is further configured to: determine that a device identification procedure is to begin in connection with a second time cycle that precedes the first time cycle; wherein the device identification procedure corresponds to the first time cycle.

Embodiment 32: The network interface device of embodiment 31, wherein the controller circuitry is further configured to: determine the quantity of transmit opportunities during the first time cycle at least by determining a quantity of first transmit opportunities during the first time cycle in which one or more other follower communication devices in the communication network transmitted; and determine that the device identification procedure is to begin at least by determining that the second time cycle includes a predetermined number of second transmit opportunity periods.

Embodiment 33: The network interface device of any of embodiments 28-32, wherein the controller circuitry is further configured to: determine the quantity of transmit opportunities during the first time cycle at least by determining a quantity of transmit opportunities during the first time cycle, and prior to a transmit opportunity of the follower communication device within the first time cycle, in which one or more other follower communication devices in the communication network transmitted; and determine the new identifier of the follower communication device at least by using the quantity of transmit opportunities during the first time cycle, and prior to the transmit opportunity of the follower communication device within the first time cycle, in which one or more other follower communication devices in the communication network transmitted.

Embodiment 34: The network interface device of embodiment 33, wherein: the first time cycle begins with a beacon from the coordinator communication device; and the controller circuitry is further configured to determine the quantity of transmit opportunities during the first time cycle, and prior to the transmit opportunity of the follower communication device within the first time cycle, in which one or more other follower communication devices in the communication network transmitted at least by counting, using a counter of the follower communication device, a number of transmit opportunities i) after the beacon, and ii) prior to a transmit opportunity that corresponds to the initial device identifier of the follower communication device.

Embodiment 35: A method for error handling in a communication network that operates according to a communication protocol, the communication protocol defining repeating time cycles, wherein the communication protocol specifies that each of multiple communication devices is provided a respective transmit opportunity in each time cycle, the method comprising: during each of at least some of the time cycles, providing, by a coordinator communication device, an additional transmit opportunity that is reserved for one or more follower communication devices to signal an error condition; and in response to receiving a transmission during the additional transmit opportunity, determining, at the coordinator communication device, that an error condition exists in the communication network.

Embodiment 36: The method of embodiment 35, further comprising: in response to determining that the error condition exists, initiating, by the coordinator communication device, a device identification procedure that involves determining a number of follower communication devices in the communication network.

Embodiment 37: A network interface device for communicating in a communication network that operates according to a communication protocol, the communication protocol defining repeating first time cycles, wherein the communication protocol specifies that each of multiple communication devices is provided a respective first transmit opportunity in each first time cycle, the network interface device being configured to operate as a coordinator communication device and comprising: receiver circuitry; transmit circuitry; and controller circuitry. The controller circuitry is configured to: during each of at least some of the time cycles, provide an additional transmit opportunity that is reserved for one or more follower communication devices to signal an error condition; and in response to receiving a transmission during the additional transmit opportunity, determine that an error condition exists in the communication network.

Embodiment 38: The network interface device of embodiment 37, wherein the controller circuitry is further configured to: in response to determining that the error condition exists, initiate a device identification procedure that involves determining a number of follower communication devices in the communication network.

Embodiment 39: A method for error handling in a communication network that operates according to a communication protocol, the communication protocol defining repeating time cycles, wherein the communication protocol specifies that each of multiple communication devices is provided a respective transmit opportunity in each time cycle, the method comprising: determining, at a follower communication device, that the follower device was not provided a transmit opportunity during one of the time cycles; and in response to determining that the follower device was not provided the transmit opportunity during the time cycle, transmitting, by the follower communication device, during an additional transmit opportunity, during the one time cycle or a subsequent time cycle, that is reserved for reporting to a coordinator communication device an error condition in the communication network.

Embodiment 40: The method of embodiment 39, wherein: the communication protocol specifies that i) the coordinator communication device is to transmit a beacon signal to signal a respective start of each time cycle; the method further comprises: receiving, at the follower communication device, a first beacon signal that signals a start of the one time cycle, and receiving, at the follower communication device, a second beacon signal that signals a start of a subsequent time cycle that follows the one time cycle; and determining that the follower device was not provided the transmit opportunity comprises determining that the follower device was not provided the transmit opportunity between the first beacon signal and the second beacon signal.

Embodiment 41: A network interface device for communicating in a communication network that operates according to a communication protocol, the communication protocol defining repeating first time cycles, wherein the communication protocol specifies that each of multiple communication devices is provided a respective first transmit opportunity in each first time cycle, the network interface device being configured to operate as a follower communication device and comprising: receiver circuitry; transmit circuitry; and controller circuitry. The controller circuitry is configured to: determine that the follower device was not provided a transmit opportunity during one of the time cycles; and in response to determining that the follower device was not provided the transmit opportunity during the time cycle, control the transmit circuitry to transmit during an additional transmit opportunity, during the one time cycle or a subsequent time cycle, that is reserved for reporting to a coordinator communication device an error condition in the communication network.

Embodiment 42: The network interface device of embodiment 41, wherein: the communication protocol specifies that i) the coordinator communication device is to transmit a beacon signal to signal a respective start of each time cycle; the controller circuitry is further configured to: receive a first beacon signal that signals a start of the one time cycle, receive a second beacon signal that signals a start of a subsequent time cycle that follows the one time cycle, and determining that the follower device was not provided the transmit opportunity at least by determining that the follower device was not provided the transmit opportunity between the first beacon signal and the second beacon signal.

Embodiment 43: A method for providing transmission opportunities in a communication network that operates according to a communication protocol, the communication protocol defining repeating first time cycles, wherein the communication protocol specifies that each of multiple communication devices is provided a respective first transmit opportunity in each first time cycle, the method comprising: signaling, by a coordinator communication device, to one or more follower devices that a device identification procedure is to begin; during the device identification procedure, providing, by the coordinator communication device, a first quantity of second transmit opportunity periods that corresponds to a maximum number of communication devices permitted in the communication network by the communication protocol; determining, at the coordinator communication device, a second quantity of second transmit opportunity periods, during the device identification procedure, that include transmissions by follower communication devices; determining, at the coordinator communication device, a quantity of first transmit opportunities to be provided in each time cycle after the identification procedure using the second quantity of second transmit opportunity periods; and after the identification procedure, providing, by the coordinator communication device, the quantity of first transmit opportunity periods during each first time cycle.

Embodiment 44: The method of embodiment 43, wherein: the communication protocol specifies that i) the coordinator communication device is to transmit a beacon signal to signal a respective start of each first time cycle; signaling that the device identification procedure is to begin comprises providing, by the coordinator communication device, the first quantity of second transmit opportunity periods during a second time cycle that precedes the device identification procedure.

Embodiment 45: The method of embodiment 44, wherein providing the first quantity of second transmit opportunity periods during the second time cycle that precedes the device identification procedure comprises: transmitting, by the coordinator device, a first beacon at a beginning of the second time cycle; and transmitting, by the coordinator device, a second beacon after an end of the second time cycle so that a time duration from an end of the first beacon and a beginning of the second beacon corresponds to the first quantity of second transmit opportunity periods.

Embodiment 46: The method of embodiment 44, wherein: the communication protocol further specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle; and the method further comprises: maintaining, at the coordinator communication device, a parameter that indicates a number of communication devices in the communication network, and in connection with signaling that the device identification procedure is to begin, setting, at the coordinator communication device, the parameter to indicate that there are the maximum number of communication devices permitted in the communication network by the communication protocol.

Embodiment 47: The method of embodiment 46, further comprising: in connection with an end of the device identification procedure, setting, at the coordinator communication device, the parameter using the second quantity of second transmit opportunity periods that include transmissions by follower communication devices.

Embodiment 48: The method of embodiment 47, further comprising: in connection with an end of the device identification procedure, determining, at the coordinator communication device, a quantity of follower communication devices in the communication network using the second quantity of second transmit opportunity periods; wherein setting the parameter using the second quantity of second transmit opportunity periods comprises setting the parameter using the quantity of follower communication devices that was determined using the second quantity of second transmit opportunity periods.

Embodiment 49: The method of embodiment 43, further comprising: during the device identification procedure, generating, at the coordinator communication device, a record that indicates each second transmit opportunity period that includes a respective transmission by a respective follower communication device.

Embodiment 50: The method of embodiment 49, wherein: each follower communication device is configured to transmit, during the device identification procedure, during a second transmit opportunity period that corresponds to an initial identifier of the follower communication device; the method further comprises determining, at the coordinator communication device, for each of one or more of the follower communication devices, a new identifier using the record, the new identifier to be used by the follower communication device to determine which first transmit opportunity period during each of at least some first time cycles corresponds to the follower communication device.

Embodiment 51: A network interface device for communicating in a communication network that operates according to a communication protocol, the communication protocol defining repeating first time cycles, wherein the communication protocol specifies that each of multiple communication devices is provided a respective first transmit opportunity in each first time cycle, the network interface device being configured to operate as a coordinator communication device and comprising: receiver circuitry; transmit circuitry; and controller circuitry. The controller circuitry is configured to: control the transmit circuitry to transmit to one or more follower devices that a device identification procedure is to begin; during the device identification procedure, provide a first quantity of second transmit opportunity periods that corresponds to a maximum number of communication devices permitted in the communication network by the communication protocol; determine a second quantity of second transmit opportunity periods, during the device identification procedure, that include transmissions by follower communication devices; determine a quantity of first transmit opportunities to be provided in each time cycle after the identification procedure using the second quantity of second transmit opportunity periods; and after the identification procedure, provide the quantity of first transmit opportunity periods during each first time cycle.

Embodiment 52: The network interface device of embodiment 51, wherein: the communication protocol specifies that i) the coordinator communication device is to transmit a beacon signal to signal a respective start of each first time cycle; the controller circuitry is configured to signal that the device identification procedure is to begin by providing the first quantity of second transmit opportunity periods during a second time cycle that precedes the device identification procedure.

Embodiment 53: The network interface device of embodiment 52, wherein the controller circuitry is configured to provide the first quantity of second transmit opportunity periods during the second time cycle at least by: controlling the transmit circuitry to transmit a first beacon at a beginning of the second time cycle; and controlling the transmit circuitry to transmit a second beacon after an end of the second time cycle so that a time duration from an end of the first beacon and a beginning of the second beacon corresponds to the first quantity of second transmit opportunity periods.

Embodiment 54: The network interface device of embodiment 52, wherein: the communication protocol further specifies that, for each first time cycle, i) each communication device in the communication network is given a respective first transmit opportunity during the first time cycle, and ii) after all communication devices in the communication network have had transmit opportunities in the first time cycle, the coordinator communication device is to transmit a next beacon signal to signal a start of a next first time cycle; and the controller is further configured to: maintain a parameter that indicates a number of communication devices in the communication network, and in connection with signaling that the device identification procedure is to begin, set the parameter to indicate that there are the maximum number of communication devices permitted in the communication network by the communication protocol.

Embodiment 55: The network interface device of embodiment 54, the controller is further configured to: in connection with an end of the device identification procedure, set the parameter using the second quantity of second transmit opportunity periods that include transmissions by follower communication devices.

Embodiment 56: The network interface device of embodiment 55, the controller is further configured to: in connection with an end of the device identification procedure, determine a quantity of follower communication devices in the communication network using the second quantity of second transmit opportunity periods; and set the parameter using the quantity of follower communication devices that was determined using the second quantity of second transmit opportunity periods.

Embodiment 57: The network interface device of embodiment 51, wherein the controller is further configured to: during the device identification procedure, generate a record that indicates each second transmit opportunity period that includes a respective transmission by a respective follower communication device.

Embodiment 58: The network interface device of embodiment 57, wherein: each follower communication device is configured to transmit, during the device identification procedure, during a second transmit opportunity period that corresponds to an initial identifier of the follower communication device; and the controller is further configured to determine, for each of one or more of the follower communication devices, a new identifier using the record, the new identifier to be used by the follower communication device to determine which first transmit opportunity period during each of at least some first time cycles corresponds to the follower communication device.

Embodiment 59: A method for determining an identifier for a communication device in a communication network that operates according to a communication protocol, the communication protocol defining repeating first time cycles, wherein the communication protocol specifies that each of multiple communication devices is provided a respective first transmit opportunity in each first time cycle, the method comprising: determining, by a follower communication device, that a device identification procedure is to begin; during the device identification procedure, transmitting, by the follower communication device, during a second transmit opportunity period that corresponds to an initial identifier of the follower communication device; determining, at the follower communication device, a quantity of second transmit opportunity periods, during the device identification procedure and prior to the second transmit opportunity period that corresponds to initial identifier of follower communication device, that include transmissions by one or more other follower communication devices; determining, at the follower communication device, a new identifier of the follower communication device that corresponds to the second quantity of second transmit opportunity periods; and after the identification procedure, determining, by the coordinator communication device, which first transmit opportunity period during each of at least some first time cycles corresponds to the follower communication device using the new identifier.

Embodiment 60: The method of embodiment 59, wherein: the communication protocol specifies that i) the coordinator communication device is to transmit a beacon signal to signal a respective start of each first time cycle; determining that the device identification procedure is to begin comprises determining, at the follower communication device, that a second time cycle that precedes the device identification procedure includes the first quantity of second transmit opportunity periods.

Embodiment 61: The method of embodiment 60, wherein determining that the second time cycle includes the first quantity of second transmit opportunity periods comprises: counting, by the follower communication device, a number of second transmit opportunity periods i) after a first beacon received at a beginning of the second time cycle, and ii) before receiving a second beacon after the second time cycle.

Embodiment 62: A network interface device for communicating in a communication network that operates according to a communication protocol, the communication protocol defining repeating first time cycles, wherein the communication protocol specifies that each of multiple communication devices is provided a respective first transmit opportunity in each first time cycle, the network interface device being configured to operate as a follower communication device and comprising: receiver circuitry; transmit circuitry; and controller circuitry. The controller circuitry is configured to: determine that a device identification procedure is to begin; during the device identification procedure, control the transmit circuitry to transmit during a second transmit opportunity period that corresponds to an initial identifier of the follower communication device; determine a quantity of second transmit opportunity periods, during the device identification procedure and prior to the second transmit opportunity period that corresponds to initial identifier of follower communication device, that include transmissions by one or more other follower communication devices; determine a new identifier of the follower communication device that corresponds to the second quantity of second transmit opportunity periods; and after the identification procedure, determine which first transmit opportunity period during each of at least some first time cycles corresponds to the follower communication device using the new identifier.

Embodiment 63: The network interface device of embodiment 62, wherein: the communication protocol specifies that i) the coordinator communication device is to transmit a beacon signal to signal a respective start of each first time cycle; and the controller is configured to determine that the device identification procedure is to begin based on determining that a second time cycle that precedes the device identification procedure includes the first quantity of second transmit opportunity periods.

Embodiment 64: The network interface device of embodiment 63, wherein the controller is configured to determine that the second time cycle includes the first quantity of second transmit opportunity periods at least by: counting a number of second transmit opportunity periods i) after a first beacon received at a beginning of the second time cycle, and ii) before receiving a second beacon after the second time cycle.

Some of the various blocks, operations, and techniques described above may be implemented utilizing hardware, a processor executing firmware instructions, a processor executing software instructions, or any suitable combination thereof. When implemented utilizing a processor executing software or firmware instructions, the software or firmware instructions may be stored in any suitable computer readable memory. The software or firmware instructions may include machine readable instructions that, when executed by one or more processors, cause the one or more processors to perform various acts such as described above.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A method for providing transmission opportunities in a communication network that operates according to a communication protocol, the communication protocol defining repeating time cycles, wherein the communication protocol specifies that each of multiple communication devices is provided a respective transmit opportunity in each time cycle, the method comprising:
determining, at a coordinator communication device, a number of follower communication devices in the communication network while the follower communication devices are selecting transmit opportunities using respective initial device identifiers;
determining, at the coordinator communication device, a quantity of transmit opportunities to be provided in each time cycle during which the follower communication devices are selecting transmit opportunities using respective new device identifiers, including determining the quantity of transmit opportunities using the number of follower communication devices; and
while the follower communication devices are selecting transmit opportunities using the respective new device identifiers, providing, by the coordinator communication device, the quantity of transmit opportunity periods in each time cycle.

2. The method of claim 1, providing the quantity of transmit opportunity periods in each time cycle comprises the providing the quantity of first transmit opportunity periods in each first time cycle, and wherein determining number of follower communication devices comprises:
providing, by the coordinator communication device, a predetermined quantity of second transmit opportunity periods during a second time cycle, wherein the predetermined quantity of second transmit opportunity periods corresponds to an expected maximum quantity of follower communication devices in the communication network;
determining, at the coordinator communication device, a quantity of second transmit opportunity periods, during the second time cycle, that include transmissions by one or more follower communication devices; and
determining, at the coordinator communication device, the number of follower communication devices using the quantity of second transmit opportunity periods that include transmissions by one or more follower communication devices.

3. The method of claim 2, wherein predetermined quantity of second transmit opportunity periods corresponds to a maximum number of communication devices permitted in the communication network by the communication protocol.

4. The method of claim 2, wherein each follower communication device is configured to transmit during a respective second transmit opportunity period that corresponds to the respective initial device identifier of the follower communication device.

5. The method of claim 2, wherein providing the predetermined quantity of second transmit opportunity periods during the second time cycle comprises:
transmitting, by the coordinator communication device, a first beacon at a beginning of the second time cycle; and
transmitting, by the coordinator communication device, a second beacon after an end of the second time cycle so that a time duration from an end of the first beacon and a beginning of the second beacon corresponds to the predetermined quantity of second transmit opportunity periods.

6. The method of claim 2, wherein providing the quantity of first transmit opportunity periods in each first time cycle comprises, in connection with each first time cycle:
transmitting, by the coordinator communication device, a first beacon at a beginning of the first time cycle; and
transmitting, by the coordinator communication device, a second beacon after an end of the first time cycle so that a time duration from an end of the first beacon and a beginning of the second beacon corresponds to the quantity of first transmit opportunity periods.

7. The method of claim 1, wherein providing the quantity of transmit opportunity periods in each time cycle comprises, in connection with each time cycle:
transmitting, by the coordinator communication device, a first beacon at a beginning of the time cycle; and
transmitting, by the coordinator communication device, a second beacon after an end of the time cycle so that a time duration from an end of the first beacon and a beginning of the second beacon corresponds to the quantity of transmit opportunity periods.

8. The method of claim 1, further comprising:
signaling, by the coordinator communication device, to one or more follower communication devices that a device identification procedure is to begin;
wherein determining the number of follower communication devices in the communication network while the follower communication devices are selecting transmit opportunities using respective initial device identifiers is performed in connection with the device identification procedure; and
wherein the follower communication devices select transmit opportunities using the respective new device identifiers after the device identification procedure.

9. The method of claim 8, wherein signaling that the device identification procedure is to begin comprises:
providing, by the coordinator communication device, a predetermined quantity of transmit opportunity periods during a time cycle that precedes the device identification procedure.

10. The method of claim 9, wherein the predetermined quantity of transmit opportunity periods corresponds to a maximum number of communication devices permitted in the communication network by the communication protocol.

11. A network interface device for communicating in a communication network that operates according to a communication protocol, the communication protocol defining repeating time cycles, wherein the communication protocol specifies that each of multiple communication devices is provided a respective transmit opportunity in each time cycle, the network interface device being configured to operate as a coordinator communication device and comprising:
receiver circuitry;
transmit circuitry; and
controller circuitry that is configured to:
determine a number of follower communication devices in the communication network while the follower communication devices are selecting transmit opportunities using respective initial device identifiers,
determine a quantity of transmit opportunities to be provided in each time cycle during which the follower communication devices are selecting transmit opportunities using respective new device identifiers, including determining the quantity of transmit opportunities using the number of follower communication devices, and
while the follower communication devices are selecting transmit opportunities using the respective new device identifiers, provide the quantity of transmit opportunity periods in each time cycle.

12. The network interface device of claim 11, where the controller circuitry is configured to:
provide the quantity of first transmit opportunity periods in each first time cycle; and
determine the number of follower communication devices at least by:
providing a predetermined quantity of second transmit opportunity periods during a second time cycle, wherein the predetermined quantity of second transmit opportunity periods corresponds to an expected maximum quantity of follower communication devices in the communication network,
determining a quantity of second transmit opportunity periods, during the second time cycle, that include transmissions by one or more follower communication devices, and
determining the number of follower communication devices using the quantity of second transmit opportunity periods that include transmissions by one or more follower communication devices.

13. The network interface device of claim 12, wherein predetermined quantity of second transmit opportunity periods corresponds to a maximum number of communication devices permitted in the communication network by the communication protocol.

14. The network interface device of claim 12, wherein each follower communication device is configured to transmit during a respective second transmit opportunity period that corresponds to the respective initial device identifier of the follower communication device.

15. The network interface device of claim 12, wherein the controller circuitry is configured to provide the predetermined quantity of second transmit opportunity periods during the second time cycle at least by:
controlling the transmit circuitry to transmit a first beacon at a beginning of the second time cycle; and
controlling the transmit circuitry to transmit a second beacon after an end of the second time cycle so that a time duration from an end of the first beacon and a beginning of the second beacon corresponds to the predetermined quantity of second transmit opportunity periods.

16. The network interface device of claim 12, wherein the controller circuitry is configured to provide the quantity of first transmit opportunity periods in each first time cycle at least by, in connection with each first time cycle:
controlling the transmit circuitry to transmit a first beacon at a beginning of the first time cycle; and
controlling the transmit circuitry to transmit a second beacon after an end of the first time cycle so that a time duration from an end of the first beacon and a beginning of the second beacon corresponds to the quantity of first transmit opportunity periods.

17. The network interface device of claim 11, wherein the controller circuitry is configured to provide the quantity of transmit opportunity periods in each time cycle at least by, in connection with each time cycle:
controlling the transmit circuitry to transmit a first beacon at a beginning of the time cycle; and
controlling the transmit circuitry to transmit a second beacon after an end of the time cycle so that a time duration from an end of the first beacon and a beginning of the second beacon corresponds to the quantity of transmit opportunity periods.

18. The network interface device of claim 11, wherein the controller circuitry is further configured to:
controlling the transmit circuitry to signal to one or more follower devices that a device identification procedure is to begin; and
determine the number of follower communication devices in the communication network while the follower communication devices are selecting transmit opportunities using respective initial device identifiers in connection with the device identification procedure;
wherein the follower communication devices select transmit opportunities using the respective new device identifiers after the device identification procedure.

19. The network interface device of claim 18, wherein the controller circuitry is further configured to signal that the device identification procedure is to begin at least by:
providing a predetermined quantity of transmit opportunity periods during a time cycle that precedes the device identification procedure.

20. The network interface device of claim 19, wherein the predetermined quantity of transmit opportunity periods corresponds to a maximum number of communication devices permitted in the communication network by the communication protocol.

21. A method for determining an identifier for a communication device in a communication network that operates according to a communication protocol, the communication protocol defining repeating time cycles, wherein the communication protocol specifies that each of multiple communication devices is provided a respective transmit opportunity in each time cycle, the method comprising:
determining, at a follower communication device, a quantity of transmit opportunities in which one or more other follower communication devices in the communication network transmitted while the one or more other follower communication devices are selecting transmit opportunities using one or more respective initial device identifiers;
determining, at the follower communication device, a new identifier of the follower communication device using the quantity of transmit opportunities in which the one or more other follower communication devices in the communication network transmitted; and
after determining the new identifier of the follower communication device, selecting, by the follower communication device, transmit opportunities for the follower communication device that correspond to the new device identifier.

22. The method of claim 21, further comprising, prior to determining the new identifier of the follower communication device:
transmitting, by the follower communication device, during a transmit opportunity period that corresponds to an initial identifier of the follower communication device.

23. The method of claim 21, wherein determining the quantity of transmit opportunities in which one or more other follower communication devices in the communication network transmitted while the one or more other follower communication devices are selecting transmit opportunities using one or more respective initial device identifiers comprises:
determining the quantity of transmit opportunities during a first time cycle in which one or more other follower communication devices in the communication network transmitted.

24. The method of claim 23, further comprising:
determining, at the follower communication device, that a device identification procedure is to begin in connection with a second time cycle that precedes the first time cycle;
wherein the device identification procedure corresponds to the first time cycle.

25. The method of claim 24, wherein:
determining the quantity of transmit opportunities during the first time cycle comprises determining a quantity of first transmit opportunities during the first time cycle in which one or more other follower communication devices in the communication network transmitted; and
determining that the device identification procedure is to begin comprises determining, at the follower communication device, that the second time cycle includes a predetermined number of second transmit opportunity periods.

26. The method of claim 21, wherein:
determining the quantity of transmit opportunities during the first time cycle comprises determining a quantity of transmit opportunities during the first time cycle, and prior to a transmit opportunity of the follower communication device within the first time cycle, in which one or more other follower communication devices in the communication network transmitted; and
determining the new identifier of the follower communication device comprises using the quantity of transmit opportunities during the first time cycle, and prior to the transmit opportunity of the follower communication device within the first time cycle, in which one or more other follower communication devices in the communication network transmitted.

27. The method of claim 26, wherein:
the first time cycle begins with a beacon from the coordinator communication device; and
determining the quantity of transmit opportunities during the first time cycle, and prior to the transmit opportunity of the follower communication device within the first time cycle, in which one or more other follower communication devices in the communication network transmitted comprises counting, by the follower communication device, a number of transmit opportunities i) after the beacon, and ii) prior to a transmit opportunity that corresponds to the initial device identifier of the follower communication device.

28. A network interface device for communicating in a communication network that operates according to a communication protocol, the communication protocol defining repeating time cycles, wherein the communication protocol specifies that each of multiple communication devices is provided a respective transmit opportunity in each time cycle, the network interface device being configured to operate as a follower communication device and comprising:
receiver circuitry;
transmit circuitry; and
controller circuitry that is configured to:
determine a quantity of transmit opportunities in which one or more other follower communication devices in the communication network transmitted while the one or more other follower communication devices are selecting transmit opportunities using one or more respective initial device identifiers,
determine a new identifier of the follower communication device using the quantity of transmit opportunities in which the one or more other follower communication devices in the communication network transmitted, and
after determining the new identifier of the follower communication device, select transmit opportunities for the follower communication device that correspond to the new device identifier.

29. The network interface device of claim 28, wherein the controller circuitry is further configured to, prior to determining the new identifier of the follower communication device:
control the transmit circuitry to transmit during a transmit opportunity period that corresponds to an initial identifier of the follower communication device.

30. The network interface device of claim 28, wherein the controller circuitry is further configured to determine the quantity of transmit opportunities in which one or more other follower communication devices in the communication network transmitted while the one or more other follower communication devices are selecting transmit opportunities using one or more respective initial device identifiers at least by:
determining the quantity of transmit opportunities during a first time cycle in which one or more other follower communication devices in the communication network transmitted.

31. The network interface device of claim 30, wherein the controller circuitry is further configured to:
determine that a device identification procedure is to begin in connection with a second time cycle that precedes the first time cycle;
wherein the device identification procedure corresponds to the first time cycle.

32. The network interface device of claim 31, wherein the controller circuitry is further configured to:
determine the quantity of transmit opportunities during the first time cycle at least by determining a quantity of first transmit opportunities during the first time cycle in which one or more other follower communication devices in the communication network transmitted; and
determine that the device identification procedure is to begin at least by determining that the second time cycle includes a predetermined number of second transmit opportunity periods.

33. The network interface device of claim 28, wherein the controller circuitry is further configured to:
determine the quantity of transmit opportunities during the first time cycle at least by determining a quantity of transmit opportunities during the first time cycle, and prior to a transmit opportunity of the follower communication device within the first time cycle, in which one or more other follower communication devices in the communication network transmitted; and
determine the new identifier of the follower communication device at least by using the quantity of transmit opportunities during the first time cycle, and prior to the transmit opportunity of the follower communication device within the first time cycle, in which one or more other follower communication devices in the communication network transmitted.

34. The network interface device of claim 33, wherein:
the first time cycle begins with a beacon from the coordinator communication device; and
the controller circuitry is further configured to determine the quantity of transmit opportunities during the first time cycle, and prior to the transmit opportunity of the follower communication device within the first time cycle, in which one or more other follower communication devices in the communication network transmitted at least by counting, using a counter of the follower communication device, a number of transmit opportunities i) after the beacon, and ii) prior to a transmit opportunity that corresponds to the initial device identifier of the follower communication device.
